(19) United States
(12) Patent Application Publication
(10) Pub. No.: US 2011/0209134 A1
(43) Pub. Date: Aug. 25, 2011

(54) INFORMATION PROCESSING APPARATUS

(75) Inventor: Yoshiyuki TODA, Kanagawa (JP)

(73) Assignee: RICOH COMPANY, LTD., Tokyo (JP)

(21) Appl. No.: 13/028,612

(22) Filed: Feb. 16, 2011

(30) Foreign Application Priority Data
Feb. 22, 2010 (JP) 2010-036447

(51) Int. Cl. G06F 9/44

(52) U.S. Cl. 717/170

(57) ABSTRACT

An information processing apparatus is disclosed, including a management part and a control part. The management part manages arrangement information of multiple firmware programs existing in a solid state drive and a device other than the solid state drive. The control part controls versions of the multiple firmware programs existing in the solid state drive based on the arrangement information managed by the management part to be a same version, when the versions of the multiple firmware programs are updated.

### BACKGROUND OF THE INVENTION

1. Field of the Invention

The present invention is related to an information processing apparatus capable of adding a device such as a HDD (Hard Disk Drive), or the like.

2. Description of the Related Art

Recently, a regular information processing apparatus allows adding a device such as the HDD or the like. Also, a portion of firmware residing in an SSD (Solid State Drive) of the information processing apparatus can be copied to a new additional HDD and a copied firmware portion can be activated.

However, in a case of updating the firmware, the portion of the firmware residing in the SDD is not updated. Accordingly, the firmware residing in the SSD includes an old version before an update and a new version after the update.

In a state in which different versions of the firmware exist in the SSD (the old version and the new version exist in the SDD), if the new additional HDD of the information processing apparatus is broken, the broken HDD is removed from the information processing apparatus and each of firmware portions existing in the SDD is activated to operate.

However, since the firmware portions existing in the SSD are different versions, the entire firmware cannot normally operate when the firmware portions are activated.

Thus, it is required to maintain all firmware portions existing in the SSD as the same version.

Japanese Laid-open Patent Publication No. 2007-295371 filed prior to the present invention discloses a technology to complete updating a device by a regular update part even in a module configuration in which a combination error occurs.

In the Japanese Laid-open Patent Publication No. 2007-295371, a system program creates a version information list by gathering version information of each of modules when the system program is activated. Next, it is determined whether or not combination condition information exists in the version information list. If the combination condition information does not exist in the version information list, a regular activation is conducted. If the combination condition information exists in the version information list, it is determined whether or not the version information satisfies the combination condition. When the version information satisfies the combination condition, the regular activation is conducted. When the version information does not satisfy the combination condition, the system program is activated in a mode specific to an update. Thus, the update can be completed even in the module configuration in which the combination error occurs.

The Japanese Laid-open Patent Publication No. 2007-295371 discloses how to complete the update even in the module configuration in which the combination error occurs. However, a technology of the Japanese Laid-open Patent Publication No. 2007-295371 is not related to a firmware configuration in which the combination error fails to occur prior to an update.

The Japanese Laid-open Patent Publication No. 2007-295371 only discloses an update of regular firmware and does not consider a firmware configuration when an additional device such as the HDD (Hard Disk Drive) or the like is mounted.

### SUMMARY OF THE INVENTION

The present invention solves or reduces one or more of the above problems.

In an aspect of this disclosure, there is provided an information processing apparatus, including a management part configured to manage arrangement information of multiple firmware programs existing in a solid state drive and a device other than the solid state drive; a control part configured to control versions of the multiple firmware programs existing in the solid state drive based on the arrangement information managed by the management part to be a same version, when the versions of the multiple firmware programs are updated.

### BRIEF DESCRIPTION OF THE DRAWINGS

In the following, embodiments of the present invention will be described with reference to the accompanying drawings.

FIG. 1 is a diagram illustrating a hardware configuration example of a controller of an information processing apparatus according to an embodiment;

FIG. 2 is a diagram illustrating a software configuration example of the controller of the information processing apparatus according to the embodiment;

FIG. 3 is a diagram illustrating a data structure of arrangement information;

FIG. 4A through FIG. 4D are diagrams illustrating a state transition of firmware when a process operation is conducted in response to additionally mounting a HDD option in a related art;

FIG. 5A through FIG. 5D are diagrams illustrating a state transition of the firmware when a first process operation is conducted in the controller according to the embodiment;

FIG. 6A through FIG. 6E are diagrams illustrating changes of the arrangement information in states illustrated in FIG. 5A through FIG. 5D;

FIG. 7A through FIG. 7D are diagrams illustrating a state transition of the firmware when a second process operation is conducted in the controller according to the embodiment;

FIG. 8A through FIG. 8E are diagrams illustrating the arrangement information in states illustrated in FIG. 7A through FIG. 7D;

FIG. 9A through FIG. 9D are diagrams illustrating a state transition of the firmware when a third process operation is conducted in the controller according to the embodiment;

FIG. 10A through FIG. 10E are diagrams illustrating the arrangement information in states illustrated in FIG. 9A through FIG. 9D;

FIG. 11A through FIG. 11D are diagrams illustrating a state transition of the firmware when a fourth process operation is conducted in the controller according to the embodiment;

FIG. 12A through FIG. 12E are diagrams illustrating the arrangement information in states illustrated in FIG. 11A through FIG. 11D;

FIG. 13A through FIG. 13D are diagrams illustrating a state transition of the firmware when the fifth process operation is conducted in the controller according to the embodiment;

FIG. 14A through FIG. 14D are diagrams illustrating the arrangement information in states illustrated in FIG. 13A through FIG. 13D;

FIG. 15A through FIG. 15D are diagrams illustrating a state transition of the firmware when the sixth process operation is conducted in the controller according to the embodiment; and

FIG. 16A through FIG. 16E are diagrams illustrating are diagrams illustrating the arrangement information in states illustrated in FIG. 15A through FIG. 15D.

### DESCRIPTION OF THE PREFERRED EMBODIMENT

In the following, an embodiment of the present invention will be described with reference to the accompanying drawings.

### <Brief Description of the Information Processing Apparatus>

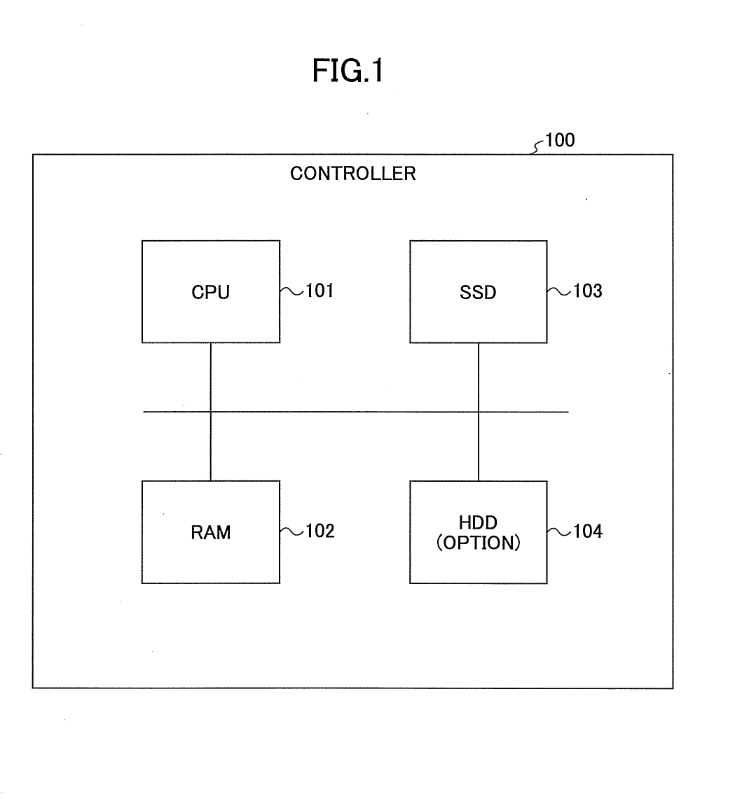

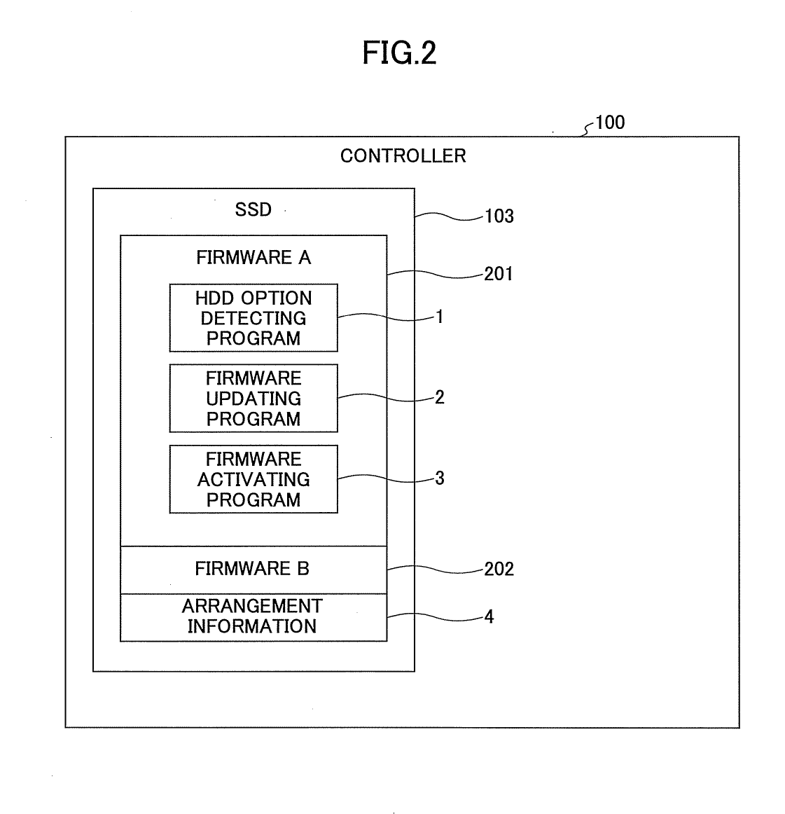

First, an information processing apparatus according to the embodiment will be described with reference to FIG. 1 and FIG. 2.

The information processing apparatus according to the embodiment manages arrangement information 4 of firmware existing in an SSD (Solid State Drive) 103 and a device (HDD (Hard Disk Drive) 104) other than the SSD 103, and controls versions of firmware programs to be the same version based on the arrangement information 4 when the firmware is updated. Hereinafter, a firmware program is simply called firmware.

By this control, in the information processing apparatus according to the embodiment, even if an additional device such as the HDD 104 or the like is mounted, versions of firmware programs existing in the SSD 103 are controlled to be the same version. In the following, details of the information processing apparatus according to the embodiment will be described with reference to the figures.

### <Hardware Configuration Example of the Controller 100 of the Information Processing Apparatus>

First, with reference to FIG. 1, a hardware configuration example of the controller 100 of the information processing apparatus according to the embodiment will be described.

The information processing apparatus according to the embodiment includes the controller 100 illustrated in FIG. 1. The controller 100 illustrated in FIG. 1 includes a CPU (Central Processing Unit) 101, a RAM (Random Access Memory) 102, the SSD (Solid State Drive) 103, and the HDD (Hard Disk Drive) 104.

The CPU 101 is a part of components configuring a computer, controls each of devices and calculates and processes data.

The RAM 102 is a storage device, and is used as a main memory of the computer.

The SSD 103 is a drive unit which uses a flash memory as a storage medium.

The HDD 104 is a device to read data recorded on a hard disk.

In this embodiment, the HDD 104 can be additionally mounted to the controller 100 as an optional device.

### <Software Configuration Example of the Controller 100>

Next, a software configuration example of the controller 100 according to the embodiment will be described with reference to FIG. 2.

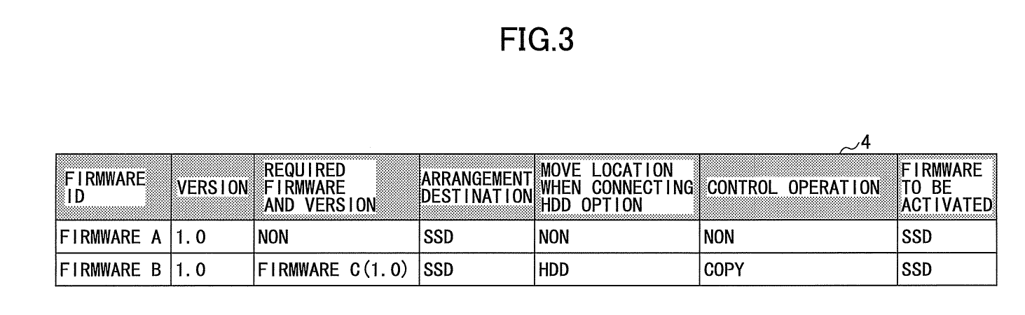

As illustrated in FIG. 2, the SSD 103 of the controller 100 in the embodiment includes functions of a firmware A 201 and a firmware B 202. The functions by the firmware A 201 and the firmware B 202 are necessary firmware functions, regardless of the HDD 104, when the controller 100 operates. Also, the SSD 103 retains the arrangement information 4 of firmware existing in the controller 100. The arrangement information 4 includes information illustrated in FIG. 3. The arrangement information 4 will be described later.

In the embodiment, the firmware A 201 includes functions conducted by a HDD option detecting program 1, a firmware updating program 2, and a firmware activating program 3.

The HDD option detecting program 1 includes a function to detect when the HDD 104 being a removable optional device is additionally mounted, when the HDD 104 is removed from the controller 100, and the like. Also, the HDD option detecting program 1 includes a function to update the arrangement information 4 based on information concerning the HDD 104 mounted in the controller 100 or the HDD 104 which is removed from the controller 100.

The firmware update program 2 specifies firmware to be updated based on the arrangement information 4 illustrated in FIG. 3 when a firmware update is conducted. Then, the firmware update program 2 updates the specified firmware.

The firmware update program 2 can simultaneously update firmware for a backup when the firmware update is conducted. Therefore, even in a case in which a device such as the HDD 104 or the like is damaged and the firmware for the backup is required to be used, the firmware for the backup can be operated and used.

The firmware activating program 3 specifies firmware to be activated based on the arrangement information 4 illustrated in FIG. 3, and activates the firmware.

By this operation, the firmware activating program 3 can activate the firmware to be activated even if the HDD 104 being the optional device is additionally mounted or if the HDD 104 is removed.

### <Arrangement Information 4 of the Firmware>

Next, the arrangement information 4 of the firmware will be described with reference to FIG. 3.

As illustrated in FIG. 3, in the arrangement information 4, items of “FIRMWARE ID”, “VERSION”, “REQUIRED FIRMWARE AND VERSION”, “ARRANGEMENT DESTINATION”, “MOVE LOCATION WHEN CONNECTING HDD OPTION”, “CONTROL OPERATION”, and “FIRMWARE TO BE ACTIVATED” are associated.

The “FIRMWARE ID” is information to specify the firmware.

The “VERSION” is information to specify the version of the firmware, and is used when the version is checked.

The “REQUIRED FIRMWARE AND VERSION” is information to specify a firmware ID and the version of another firmware which the firmware uses.

The “ARRANGEMENT DESTINATION” is information to specify an arrangement destination of the firmware. The “ARRANGEMENT DESTINATION” may indicate multiple locations since the firmware is loaded into multiple devices by optionally adding the HDD 104. When updating the firmware, the firmware updating program 2 specifies an arrangement destination of the firmware, which is subject to be updated, based on the “ARRANGEMENT DESTINATION”, and updates the firmware loaded at the arrangement destination.

The “MOVE LOCATION WHEN CONNECTING HDD OPTION” is information to specify a device to which the firmware is moved. When the HDD 104 is optionally connected to the controller 100, the HDD option detecting program 1 specifies a device to move, based on information of the “MOVE LOCATION WHEN CONNECTING HDD OPTION”, and moves the firmware to the device indicated by the “MOVE LOCATION WHEN CONNECTING HDD OPTION”.

The “CONTROL OPERATION” is information to specify a control operation conducted when the HDD 104 is additionally mounted. The control operation is an operation (move) of completely moving the firmware to the device indicated by the “MOVE LOCATION” and deleting the firmware loaded at an original location, an operation (copy) of copying the firmware to the device indicated by the “MOVE LOCATION” and retaining the firmware at the original location, a non-operation (non), or the like. When the HDD 104 is additionally mounted, the HDD option detecting program 1 controls to move or copy the firmware, or do nothing to the firmware or the like, based on the information of the “CONTROL OPERATION”.

The “FIRMWARE TO BE ACTIVATED” is information to specify in which device the firmware is to be activated. When activating the firmware, the firmware activating program 3 specifies in which device the firmware is to be activated, based on information of the “FIRMWARE TO BE ACTIVATED”, and activates the specified firmware to be activated.

In the arrangement information 4 illustrated in FIG. 3, for the firmware A 201, the “FIRMWARE ID” indicates “FIRMWARE A”, the “VERSION” indicates “1.0”, the “REQUIRED FIRMWARE AND VERSION” is “NON”, the “ARRANGEMENT DESTINATION” is “SSD”, the “MOVE LOCATION WHEN CONNECTING HDD OPTION” indicates “NON”, the “CONTROL OPERATION” indicates “NON”, and the “FIRMWARE TO BE ACTIVATED” indicates “SSD”.

Also, for the firmware B 202, the “FIRMWARE ID” indicates “FIRMWARE B”, the “VERSION” indicates “1.0”, the “REQUIRED FIRMWARE AND VERSION” indicates “FIRMWARE C (1.0)”, the “ARRANGEMENT DESTINATION” indicates “SSD”, the “MOVE LOCATION WHEN CONNECTING HDD OPTION” indicates “HDD”, the “CONTROL OPERATION” indicates “COPY”, and the “FIRMWARE TO BE ACTIVATED” indicates “SSD”.

### <Process Operation of the Controller 100>

Next, a process operation example of the controller 100 will be described.

### <Related Process Operation When the HDD Option is Mounted>

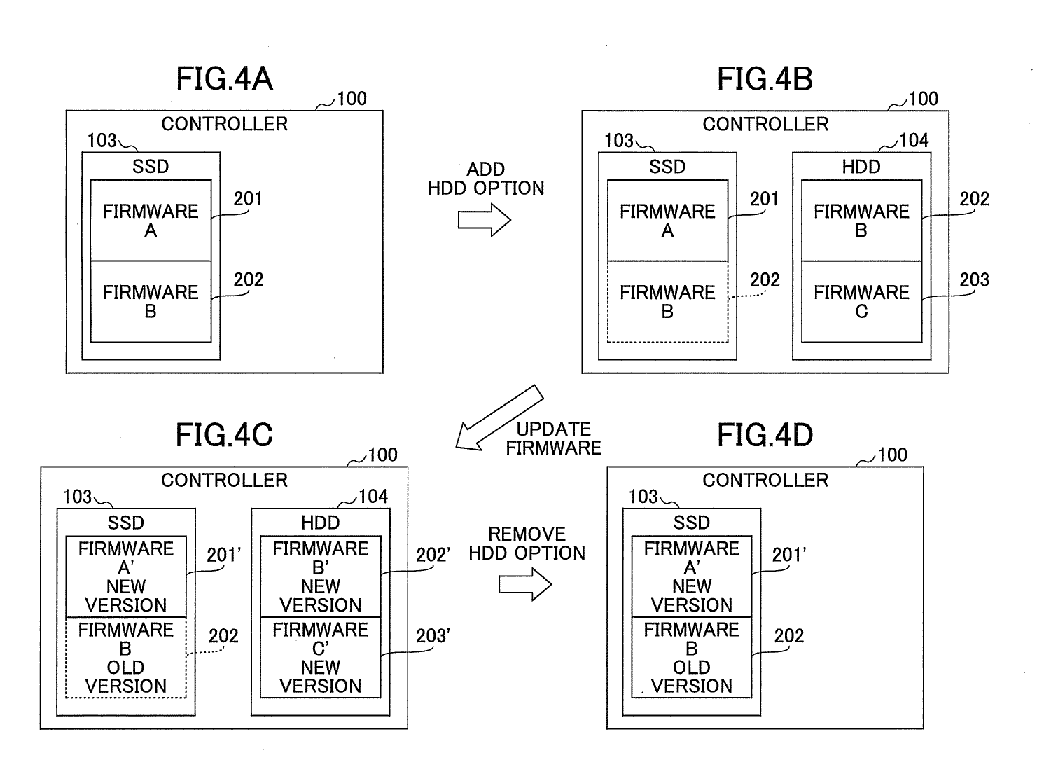

First, referring to FIG. 4A through FIG. 4D, a related process operation, which is conducted when the HDD 104 as an option is additionally mounted, will be described. As illustrated in FIG. 4A, it is assumed that the SSD 103 is mounted in the controller 100, and the HDD 104 is not mounted. A case in which the HDD 104 as the HDD option is to be additionally mounted in the controller 100 illustrated in FIG. 4A will be described. In FIG. 4A through FIG. 4C, the firmware A 201 and the firmware B 202 provide functions required for an operation of the controller 100, regardless of a presence or absence of the HDD 104. Also, a firmware C 203 provides a function required only when the HDD 104 is additionally mounted.

In a case of mounting the HDD option in the controller 100 in a state illustrated in FIG. 4A, when the HDD 104 is additionally added to the controller 100 as illustrated in FIG. 4B, the SSD 103 controls the firmware to be a state illustrated in FIG. 4B.

In detail, in the case of mounting the HDD option, the SSD 103 copies the firmware B 202 existing in the SSD 103 and activates the firmware B 202 copied to the HDD 104 to be activated and operated. It should be noted that the SSD 103 also retains the firmware B 202 being original in the SSD 103.

Moreover, the SSD 103 activates and operates the firmware C 203 existing in the HDD 104 which is additionally mounted to the controller 100. Furthermore, the SSD 103 activates and operates the firmware A 201 existing in the SSD 103.

By the above-described control of the SSD 103, the firmware A 201 existing in the SSD 103, the firmware B 202 copied to the HDD 104, and the firmware C 203 existing in the HDD 104 are activated to operate.

Next, in a state illustrated in FIG. 4B, it is assumed that the firmware is updated. In this case, since the SSD 103 causes the firmware A 201 existing in the SSD 103, the firmware B 202 copied to the HDD 104, and the firmware C 203 existing in the HDD 104 to activate and operate, the SSD 103 updates the firmware A 201 of the SSD 103, the firmware B 202 of the HDD 104, and the firmware C 203. A state after the firmware is updated is illustrated in FIG. 4C. Firmware A′ 201′ of the SSD 103, firmware B′ 202′ of the HDD 104, and firmware C′ 203′ are updated and become new versions. However, since the firmware B 202 of the SSD 103 is not updated, the firmware B 202 is an old version. Therefore, a version of the firmware A′ 201′ existing in the SSD 103 is different from that of the firmware B 202 existing in the SSD 103.

As illustrated in FIG. 4C, in a state in which the version of the firmware A′ 201′ existing in the SSD 103 is different from that of the firmware B 202 existing in the SSD 103, since an error or the like occurs with the HDD 104, the HDD 104 as the HDD option is removed and the state illustrated in FIG. 4C is transitioned to a state illustrated in FIG. 4D. In FIG. 4D, the HDD 104 is removed from the controller 100.

Accordingly, in the state illustrated in FIG. 4D, if the firmware A′ 201′ and the firmware B 202 both existing in the SSD 103 are activated, the firmware A′ 201′ and the firmware B 202 do not normally operate due to different versions between the firmware A′ 201′ and the firmware B 202.

Thus, the versions of the firmware A′ 201′ and the firmware B 202 both existing in the SSD 103 are required to be new versions.

In order to solve the above problem, in the embodiment, the versions of the firmware A 201 and the firmware B 202 both existing in the SSD 103 can be the same version by performing the following control operation.

### <First Process Operation>

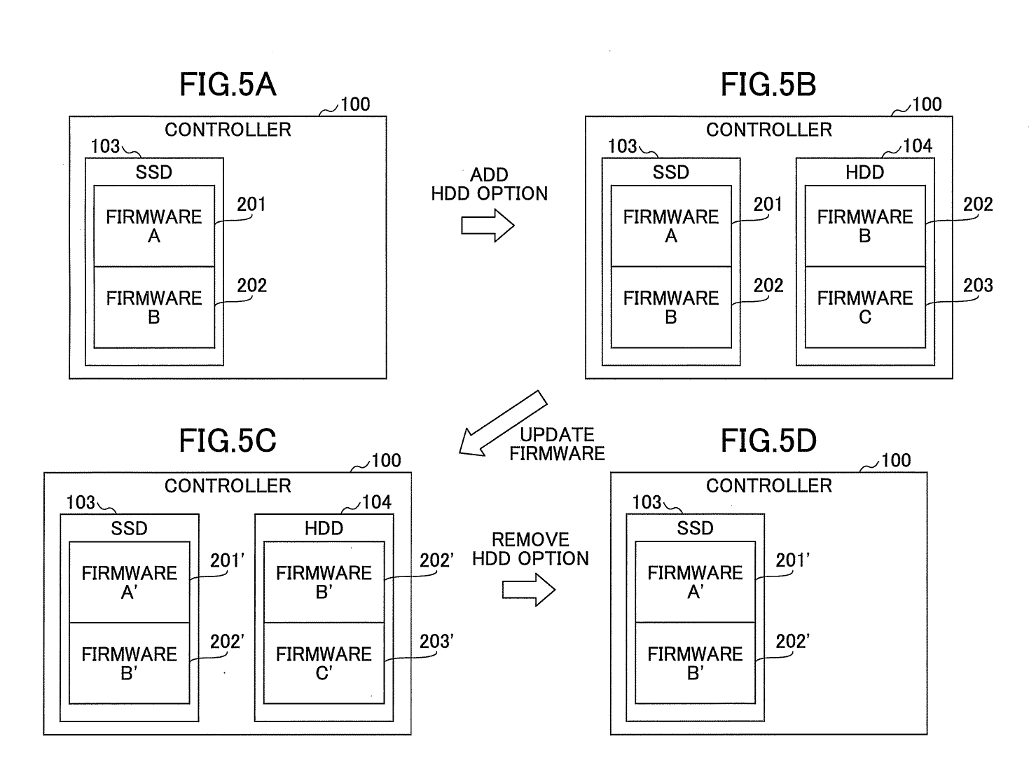

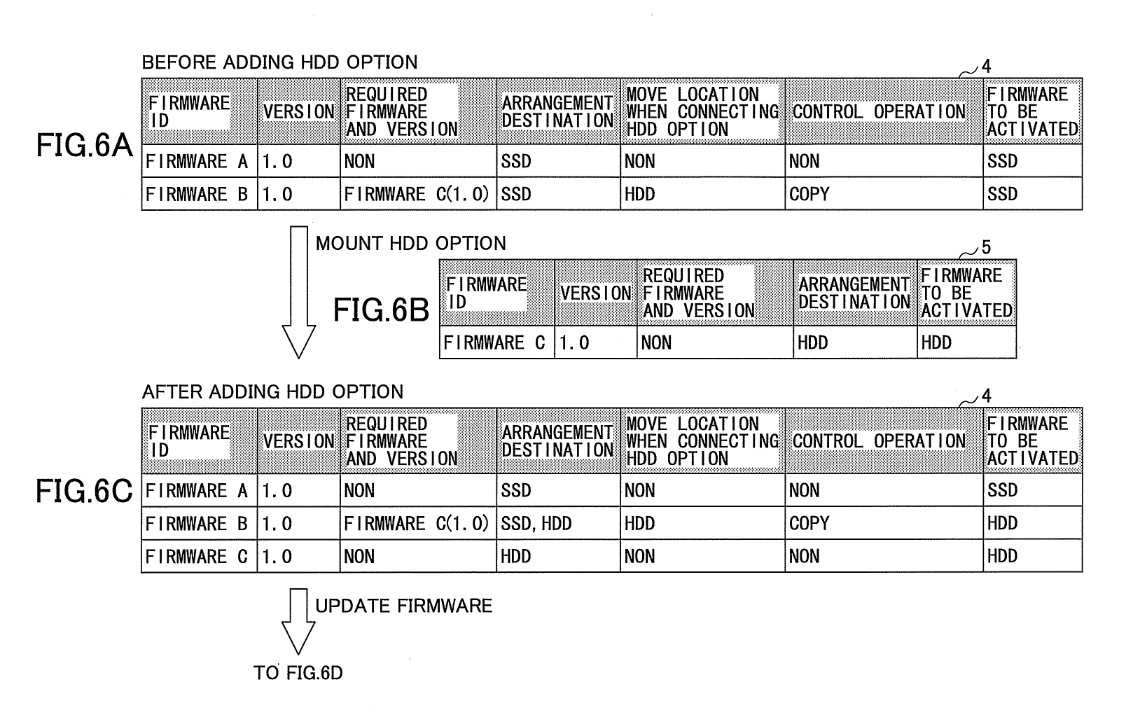

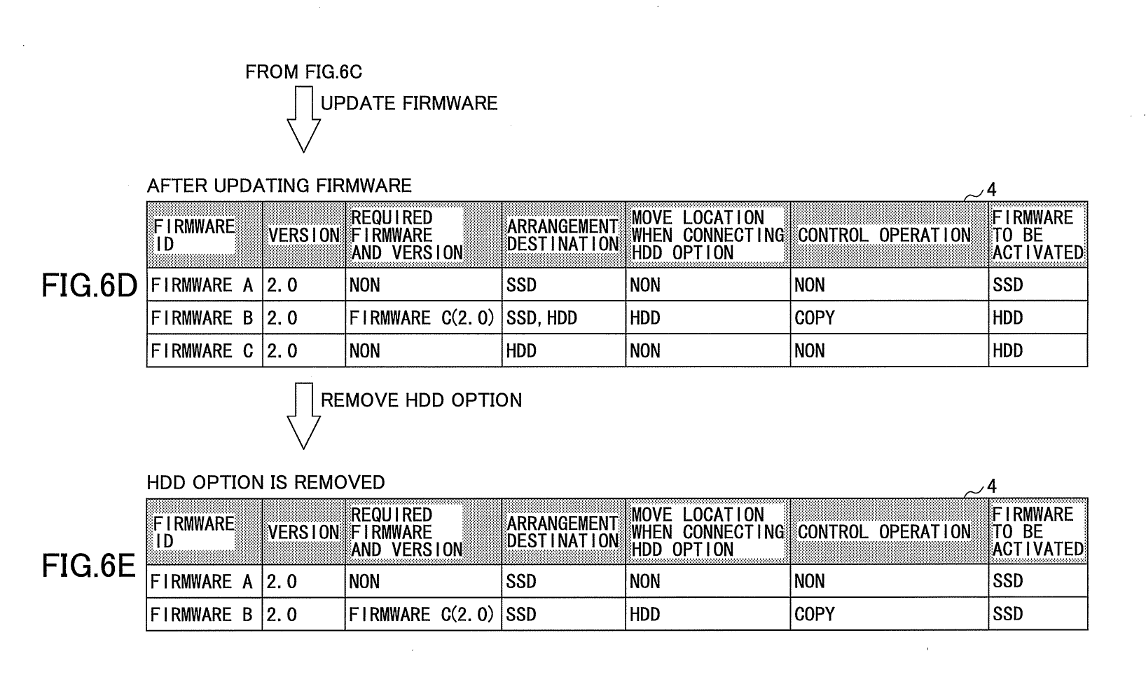

First, a first process operation will be described with reference to FIG. 5A through FIG. 5D and FIG. 6A through FIG. 6E. FIG. 5A through FIG. 5D are diagrams illustrating a state transition of the firmware when the first process operation is conducted. FIG. 6A through FIG. 6E are diagrams illustrating changes of the arrangement information 4 in states illustrated in FIG. 5A through FIG. 5D. The first process operation will be described in a case in which the firmware B 202 of the SSD 103 is copied to the HDD 104 when the HDD 104 as the HDD option is additionally mounted in the controller 100, and the firmware B 202 which is original is retained in the SSD 103.

In a case of the controller 100 in a state illustrated in FIG. 5A, the SSD 103 stores the arrangement information 4 illustrated in FIG. 6A beforehand. Data of the arrangement information 4 in FIG. 6A is the same as data of the arrangement information 4 illustrated in FIG. 3. Also, it is assumed that the HDD 104 as the HDD option additionally mounted to the controller 100 retains information 5 of the firmware C 203 illustrated in FIG. 6B. In the information 5 of the firmware C 203 in FIG. 6B, items of “FIRMWARE ID”, “VERSION”, “REQUIRED FIRMWARE AND VERSION”, “ARRANGEMENT DESTINATION”, and “FIRMWARE TO BE ACTIVATED” are associated.

As illustrated in FIG. 5B, when the HDD 104 as the HDD option is additionally mounted in the controller 100 in the state illustrated in FIG. 5A, the SSD 103 controls the firmware to be the state illustrated in FIG. 5B.

In detail, when the HDD 104 as the HDD option is additionally mounted, the HDD option detecting program 1 copies the firmware B 202 existing in the SSD 103 to the HDD 104 based on information of the “MOVE LOCATION WHEN CONNECTING HDD OPTION” and the “CONTROL OPERATION” of the arrangement information 4 illustrated in the FIG. 6A.

Next, the HDD option detecting program 1 changes the arrangement information 4 illustrated in FIG. 6A to the arrangement information 4 illustrated in FIG. 6C, based on the state illustrated in FIG. 5B when an addition of the HDD 104 as the HDD option is completed.

In detail, since the firmware B 202 is copied to the HDD 104, in FIG. 6C, the HDD option detecting program 1 updates information of the “ARRANGEMENT DESTINATION” of the “FIRMWARE B” from “SSD” to “SSD, HDD” and also updates information of the “FIRMWARE TO BE ACTIVATED” from “SSD” to “HDD”. Accordingly, it is possible to cause the firmware B 202 copied to the HDD 104 to operate, to retain the firmware B 202 being the original in the SSD 103 as backup firmware, and to suppress an operation of the firmware B 202 in the SSD 103.

Also, since the HDD 104, which is added to the controller 100 as the HDD option is mounted, retains information 5 of the firmware C 203 depicted in FIG. 6B, the HDD option detecting program 1 adds the information 5 of the firmware C 203 depicted in FIG. 6B to the arrangement information 4 depicted in FIG. 6A, based on the information 5 of the firmware C 203 depicted in FIG. 6B which is retained by the HDD 104, so as to update the arrangement information 4 as depicted in FIG. 6C. Thus, the firmware activating program 3 activates the firmware C 203 of the HDD 104 based on the information “FIRMWARE TO BE ACTIVATED” of the arrangement information depicted in FIG. 6C, so that the firmware C 203 starts to operate.

Next, in a state illustrated in FIG. 5B, it is assumed that a firmware update is conducted. In this case, the firmware updating program 2 specifies the arrangement destination of firmware to be updated based on the information of the “ARRANGEMENT DESTINATION” of the arrangement information 4 in FIG. 6C, and updates the firmware loaded at the “ARRANGEMENT DESTINATION”. In a case of the arrangement information 4 in FIG. 6C, since the “ARRANGEMENT DESTINATION” of the “FIRMWARE A” indicates “SSD”, the firmware A 201 existing in the SSD 103 is updated. Moreover, since the “ARRANGEMENT DESTINATION” of the “FIRMWARE B” indicates “SSD, HDD”, the firmware updating program 2 updates the firmware B 202 existing in the SSD 103 and the firmware B 202 existing in the HDD 104. Furthermore, since the “ARRANGEMENT DESTINATION” of the “FIRMWARE C” indicates “HDD”, the firmware updating program 2 updates the firmware C 203 existing in the HDD 104.

Accordingly, by using the firmware updating program 2, it is possible to update the firmware B 202 existing in the SSD 103 which is not a subject to be activated, in addition to the firmware A 201 existing in the SSD 103, the firmware B 202 existing in the HDD 104, and the firmware C 203 existing in the HDD 104 which are subjects to be activated. As a result, the firmware updating program 2 can update the arrangement information 4 in FIG. 6C to be the arrangement information 4 in FIG. 6D.

Therefore, in the controller 100 according to the embodiment, there is no version difference as illustrated in the state in FIG. 4C between the firmware A′ 201′ and the firmware B 202 in the SSD 103. Thus, as the state in FIG. 5C, the versions of the firmware A′ 201′ and the firmware B′ 202′ are the same.

Accordingly, in a state in which the versions of the firmware A′ 201′ and the firmware B′ 202′ are the same as illustrated in FIG. 5C, it is assumed that an error of the HDD 104 occurs, the HDD 104 as the HDD option is removed, and the state in FIG. 5C is transitioned to the state illustrated in FIG. 5D. Accordingly, in the state illustrated in FIG. 5D, when the firmware A′ 201′ and the firmware B′ 202′ existing in the SSD 103 are activated, operations of the firmware A′ 201′ and the firmware B′ 202′ are normally conducted.

When the HDD 104 as the HDD option is removed, the HDD option detecting program 1 updates information of the “FIRMWARE B” and the “FIRMWARE C” of the arrangement information 4 in FIG. 6D to acquire the arrangement information 4 in FIG. 6E. Since the HDD 104 is removed from the controller 100 in FIG. 5D, the information of the “ARRANGEMENT DESTINATION” of the “FIRMWARE B” is updated from “SSD, HDD” to “SSD” in FIG. 6D, and the information of the “FIRMWARE TO BE ACTIVATED” is updated from “HDD” to “SSD” in FIG. 6D. In addition, the information of the “FIRMWARE C” in FIG. 6D is deleted from the arrangement information 4. As a result, the HDD option detecting program 1 updates the arrangement information 4 in FIG. 6D to the arrangement information 4 in FIG. 6E.

### <Second Process Operation>

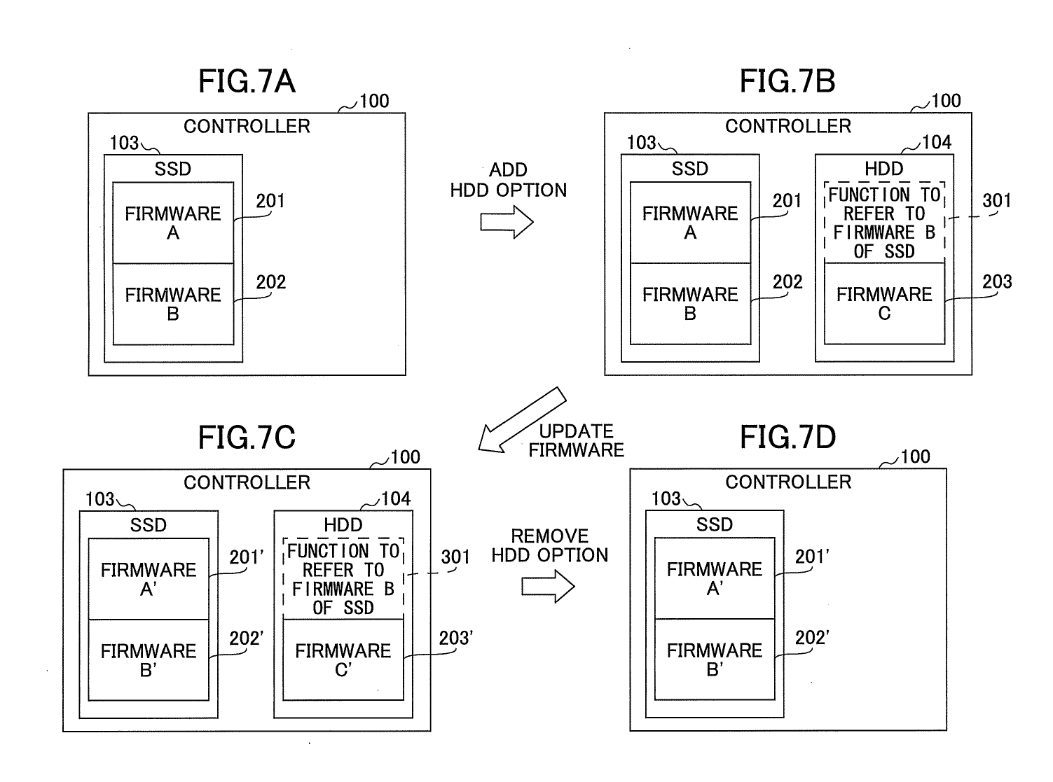

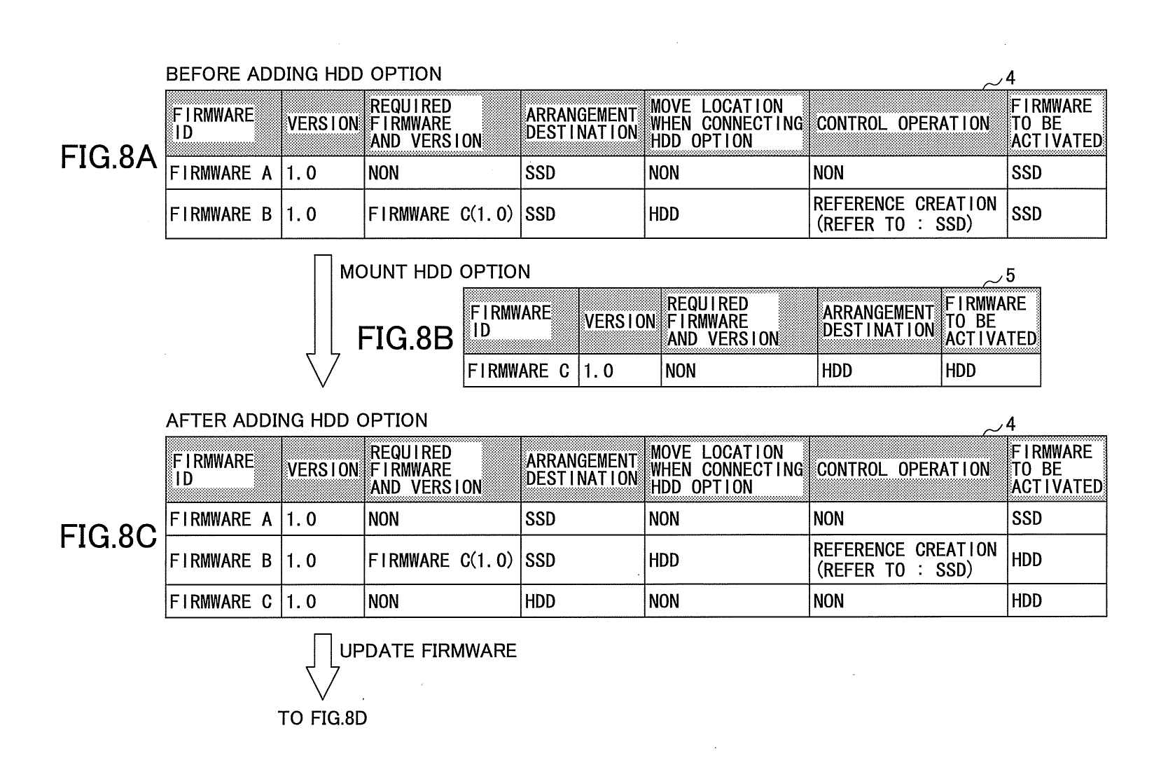

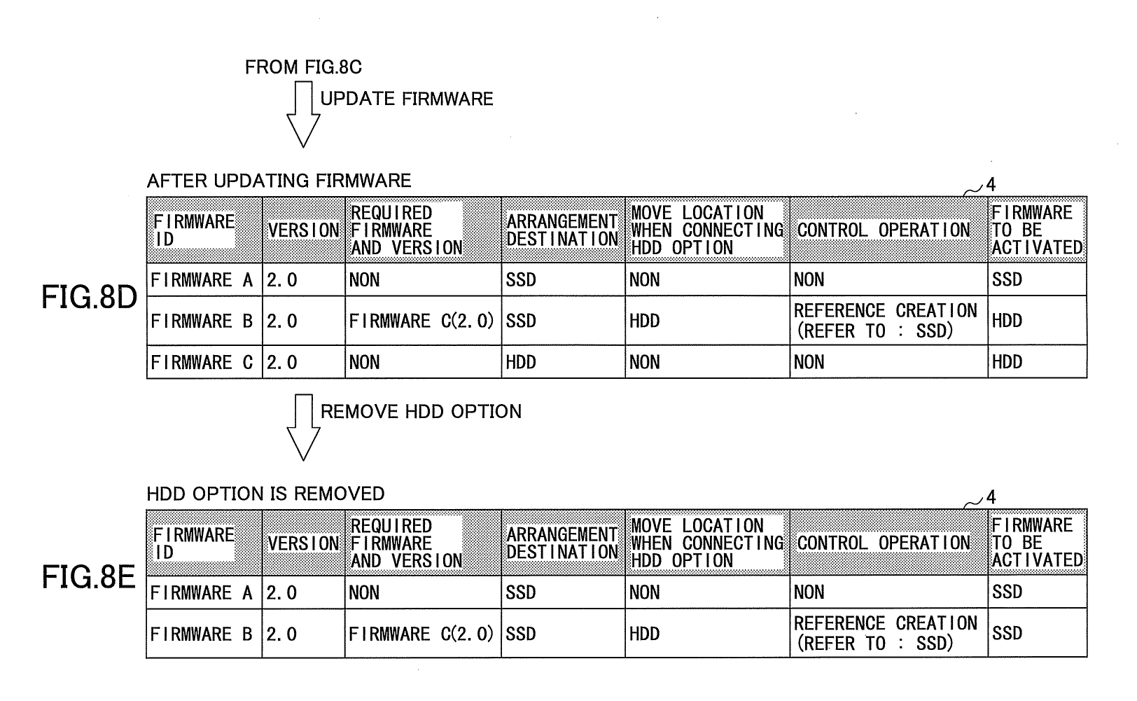

A second process operation will be described with reference to FIG. 7A through FIG. 7D and FIG. 8A through FIG. 8E. FIG. 7A through FIG. 7D are diagrams illustrating a state transition of the firmware when the second process operation is conducted. FIG. 8A through FIG. 8E are diagrams illustrating the arrangement information 4 in states illustrated in FIG. 7A through FIG. 7D. The second process operation will be described in a case in which the firmware B 202 is retained in the SSD 103, and a reference function 301 to refer to the firmware B 202 of the SSD 103 is created in the HDD 104.

In a case of the controller 100 in the state illustrated in FIG. 7A, the SSD 103 stores the arrangement information 4 illustrated in FIG. 8A beforehand. In the arrangement information 4 illustrated in FIG. 8A, information of the “CONTROL OPERATION” indicates to create the reference function 301 (“REFERENCE CREATION”). Also, “SSD” is indicated to be referred to (“REFER TO: SSD”). Moreover, the HDD 104, which is added to the controller 100 as the HDD option to be mounted, retains information 5 of the firmware C 203 illustrated in FIG. 8B.

When as illustrated in FIG. 7B, the HDD 104 as the HDD option is additionally mounted in the controller 100 in the state illustrated in FIG. 7A, the SSD 103 controls the firmware B 202 to be the state illustrated in FIG. 7B.

In detail, when the HDD 104 is additionally mounted, the HDD option detecting program 1 creates the reference function 301 to refer to the firmware B 202 of the SSD 103 based on the information of the “MOVE LOCATION WHEN CONNECTING HDD OPTION” and the “CONTROL OPERATION” of the arrangement information 4 illustrated in FIG. 8A. The firmware B 202 of the SSD 103 can be activated by using the reference function 301. Moreover, different from the first process operation, since an entity of the firmware B 202 in the HDD 104 in the second process operation is not required to be in the HDD 104, it is possible to reduce a use amount of the HDD 104.

Next, when the HDD 104 as the HDD option is completely mounted in the controller 100, as illustrated in FIG. 8C, the HDD option detecting program 1 updates the arrangement information 4 illustrated in FIG. 8A based on the state illustrated in FIG. 7B.

In detail, the HDD 104, which is additionally mounted in the controller 100 as the HDD option, retains information 5 of the firmware C 203 illustrated in FIG. 8B. Thus, the HDD option detecting program 1 adds the information 5 of the firmware C 203 illustrated in FIG. 8B to the arrangement information 4 illustrated in FIG. 8A based on the information 5 of the firmware C 203 illustrated in FIG. 8B which is retained in the HDD 104, so that the arrangement information 4 is updated as illustrated in FIG. 8C. By the firmware activating program 3, based on the information of the “FIRMWARE TO BE ACTIVATED” of the arrangement information 4 illustrated in FIG. 8C, the firmware C 203 of the HDD 104 is activated and operates.

Next, in the state illustrated in FIG. 7B, the firmware A 201, the firmware B 202, and the firmware C 203 are updated. In this case, the firmware updating program 2 specifies the arrangement destination of firmware to be updated based on the information of the “ARRANGEMENT DESTINATION” of the arrangement information 4 illustrated in FIG. 8C, and updates the firmware loaded at the specified arrangement destinations. In a case of the arrangement information 4 illustrated in FIG. 8C, since the “ARRANGEMENT DESTINATION” of the “FIRMWARE A” indicates “SSD”, the firmware updating program 2 updates the firmware A 201 existing in the SSD 103. Since the “ARRANGEMENT DESTINATION” of the “FIRMWARE B” indicates “SSD”, the firmware updating program 2 updates the firmware B 202 existing in the SSD 103.

Since the “ARRANGEMENT DESTINATION” of the “FIRMWARE C” indicates “HHD”, the firmware updating program 2 updates the firmware C 203 existing in the HDD 104.

Accordingly, the firmware updating program 2 can update the firmware A 201 in the SSD 103, the firmware B 202 in the SSD 103, and the firmware C 203 existing in the HDD 104, which are subjects to be activated. As a result, the firmware updating program 2 can update the arrangement information 4 illustrated in FIG. 8C to be the arrangement information 4 illustrated in FIG. 8D.

Therefore, in the controller 100 according to the embodiment, there is no version difference as illustrated in the state in FIG. 4C between the firmware A′ 201′ and the firmware B 202 in the SSD 103. Thus, as the state in FIG. 7C, the versions of the firmware A′ 201′ and the firmware B′ 202′ are the same.

Accordingly, in a state in which the versions of the firmware A′ 201′ and the firmware B′ 202′ are the same as illustrated in FIG. 7C, it is assumed that an error of the HDD 104 occurs, the HDD 104 as the HDD option is removed, and the state in FIG. 7C is transitioned to the state illustrated in FIG. 7D. Accordingly, in the state illustrated in FIG. 7D, when the firmware A′ 201′ and the firmware B′ 202′ existing in the SSD 103 are activated, operations of the firmware A′ 201′ and the firmware B′ 202′ are normally conducted.

When the HDD 104 as the HDD option is removed, the HDD option detecting program 1 updates the information of the “FIRMWARE B” and the “FIRMWARE C” of the arrangement information 4 in FIG. 8D, so that the arrangement information 4 is set as illustrated in FIG. 8E. Since the HDD 104 is removed from the controller 100 in FIG. 7D, the information of the “ARRANGEMENT DESTINATION” of the “FIRMWARE B” is updated from “SSD, HDD” to “SSD” in FIG. 8D, and the information of the “FIRMWARE TO BE ACTIVATED” is updated from “HDD” to “SSD” in FIG. 8D. In addition, the information of the “FIRMWARE C” in FIG. 8D is deleted from the arrangement information 4. As a result, the HDD option detecting program 1 updates the arrangement information 4 in FIG. 8D to be the arrangement information 4 in FIG. 8E.

### <Third Process Operation>

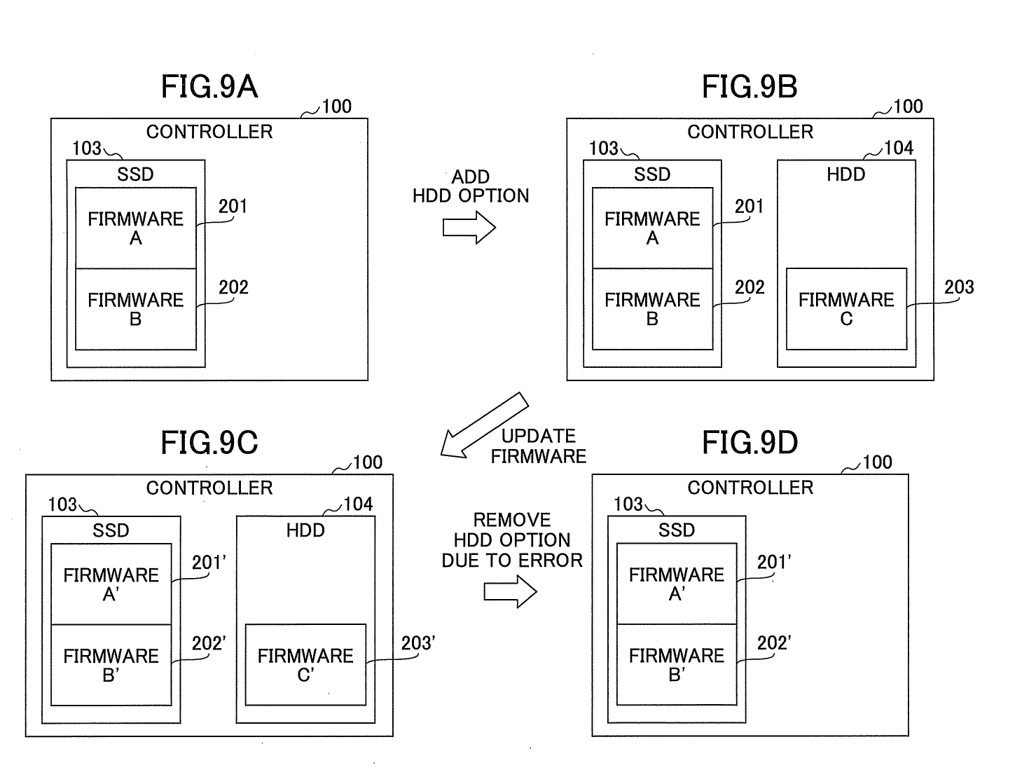

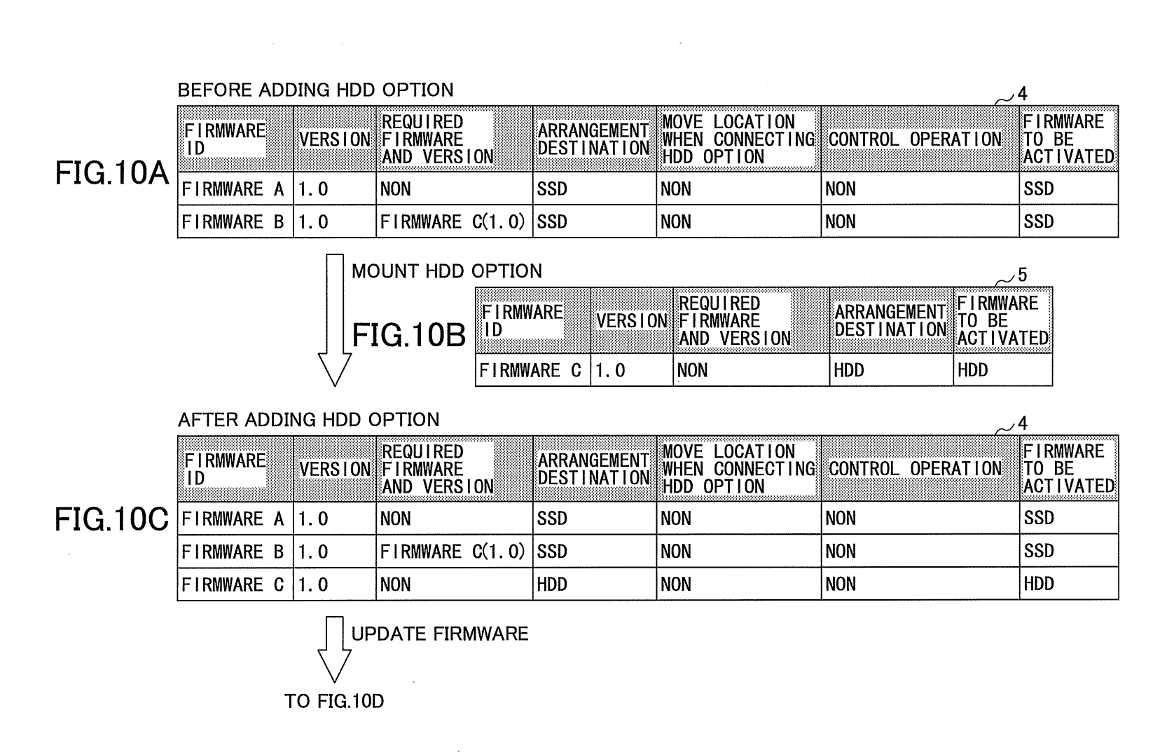

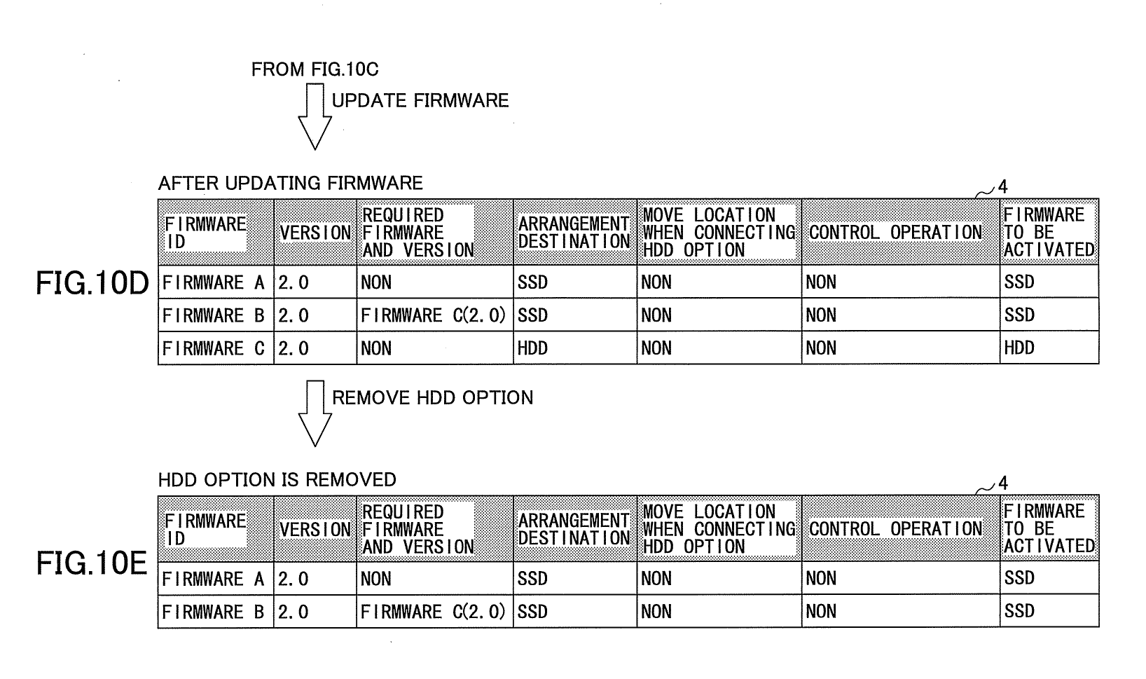

Next, a third process operation will be described with reference to FIG. 9A through FIG. 9D and FIG. 10A through FIG. 10E. FIG. 9A through FIG. 9D are diagrams illustrating a state transition of the firmware when the third process operation is conducted. FIG. 10A through FIG. 10E are diagrams illustrating the arrangement information 4 in states illustrated in FIG. 9A through FIG. 9D. The third process operation will be described in a case in which when the HDD 104 is additionally mounted as the HDD option, and the firmware B 202 is retained in the SSD 103, instead of copying the firmware B 202 to the HDD 104.

In a case of the controller 100 in the state illustrated in FIG. 9A, the SSD 103 stores the arrangement information 4 illustrated in FIG. 10A beforehand. In the arrangement information 4 illustrated in FIG. 10A, the information of the “CONTROL OPERATION” indicates to do nothing (“NON”). Moreover, the HDD 104, which is added to the controller 100 as the HDD option to be mounted, retains information 5 of the firmware C 203 illustrated in FIG. 10B.

When as illustrated in FIG. 9B, the HDD 104 as the HDD option is additionally mounted in the controller 100 in the state illustrated in FIG. 9A, the SSD 103 controls the firmware B 202 to be the state illustrated in FIG. 9B.

In detail, when the HDD 104 is additionally mounted, the HDD option detecting program 1 suppresses copying the firmware B 202 to the HDD 104 based on the information of the “MOVE LOCATION WHEN CONNECTING HDD OPTION” and the “CONTROL OPERATION” of the arrangement information 4 illustrated in FIG. 10A. Thus, different from the first process operation, since an entity of the firmware B 202 in the HDD 104 in the third process operation is not required to be in the HDD 104, it is possible to reduce a use amount of the HDD 104.

Next, when the HDD 104 as the HDD option is completely mounted in the controller 100, as illustrated in FIG. 10C, the HDD option detecting program 1 updates the arrangement information 4 illustrated in FIG. 10A based on the state illustrated in FIG. 9B.

In detail, the HDD 104, which is additionally mounted in the controller 100 as the HDD option, retains information 5 of the firmware C 203 illustrated in FIG. 10B. Thus, the HDD option detecting program 1 adds the information 5 of the firmware C 203 illustrated in FIG. 10B to the arrangement information 4 illustrated in FIG. 10A based on the information 5 of the firmware C 203 illustrated in FIG. 10B which is retained in the HDD 104, so that the arrangement information 4 is updated as illustrated in FIG. 10C. By using the firmware activating program 3, based on the information of the “FIRMWARE TO BE ACTIVATED” of the arrangement information 4 illustrated in FIG. 10C, the firmware C 203 of the HDD 104 is activated and operates.

Next, in the state illustrated in FIG. 9B, it is assumed that the firmware A 201, the firmware B 202, and the firmware C 203 are updated. In this case, the firmware updating program 2 specifies the arrangement destination of firmware to be updated based on the information of the “ARRANGEMENT DESTINATION” of the arrangement information 4 illustrated in FIG. 10C, and updates the firmware loaded at the specified arrangement destination. In a case of the arrangement information 4 illustrated in FIG. 10C, since the “ARRANGEMENT DESTINATION” of the “FIRMWARE A” indicates “SSD”, the firmware updating program 2 updates the firmware A 201 existing in the SSD 103. Since the “ARRANGEMENT DESTINATION” of the “FIRMWARE B” indicates “SSD”, the firmware updating program 2 updates the firmware B 202 existing in the SSD 103. Since the “ARRANGEMENT DESTINATION” of the “FIRMWARE C” indicates “HHD”, the firmware updating program 2 updates the firmware C 203 existing in the HDD 104.

Accordingly, the firmware updating program 2 can update the firmware A 201 in the SSD 103, the firmware B 202 in the SSD 103, and the firmware C 203 existing in the HDD 104, which are subjects to be activated.

Therefore, in the controller 100 according to the embodiment, there is no version difference as illustrated in the state in FIG. 4C between the firmware A′ 201′ and the firmware B 202 in the SSD 103. Thus, as the state in FIG. 9C, the versions of the firmware A′ 201′ and the firmware B′ 202′ are the same.

Accordingly, in a state in which the versions of the firmware A′ 201′ and the firmware B′ 202′ are the same as illustrated in FIG. 9C, it is assumed that an error of the HDD 104 occurs, the HDD 104 as the HDD option is removed, and the state in FIG. 9C is transitioned to the state illustrated in FIG. 9D. Accordingly, in the state illustrated in FIG. 9D, when the firmware A′ 201′ and the firmware B′ 202′ existing in the SSD 103 are activated, operations of the firmware A′ 201′ and the firmware B′ 202′ are normally conducted.

When the HDD 104 as the HDD option is removed, the HDD option detecting program 1 updates information of the “FIRMWARE C” of the arrangement information 4 in FIG. 10D, so that the arrangement information 4 is set as illustrated in FIG. 10E. Since the HDD 104 is removed from the controller 100 in FIG. 9D, the information of the “FIRMWARE B” is deleted from the arrangement information 4. As a result, the HDD option detecting program 1 updates the arrangement information 4 in FIG. 10D to be the arrangement information 4 in FIG. 10E.

### <Fourth Process Operation>

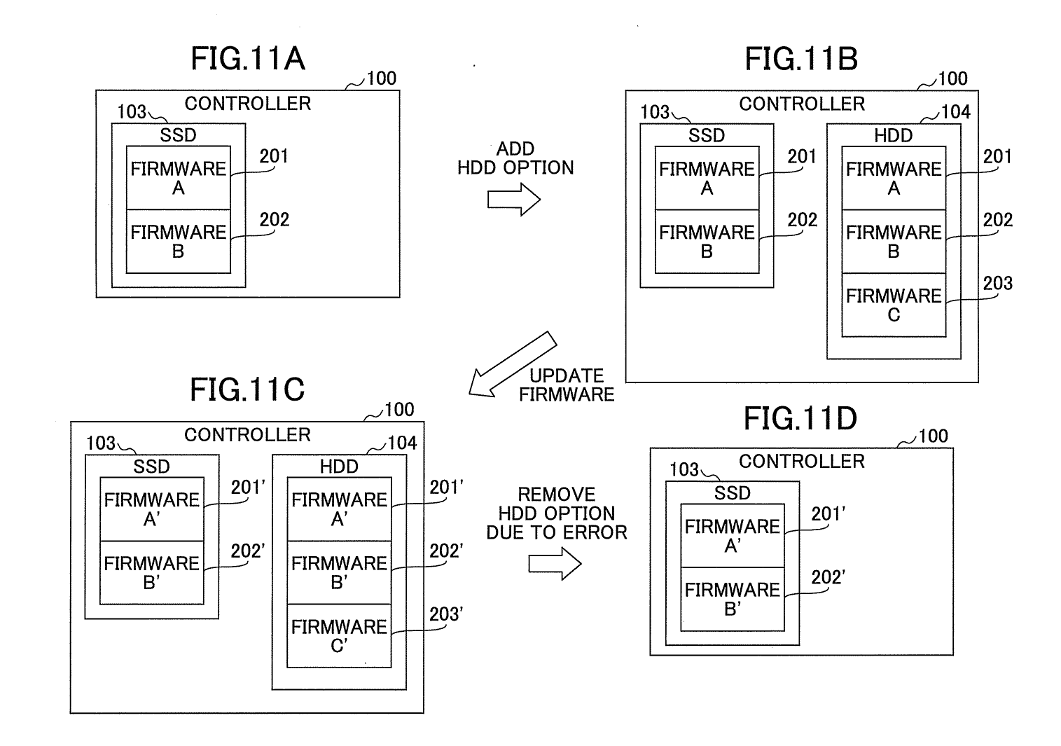

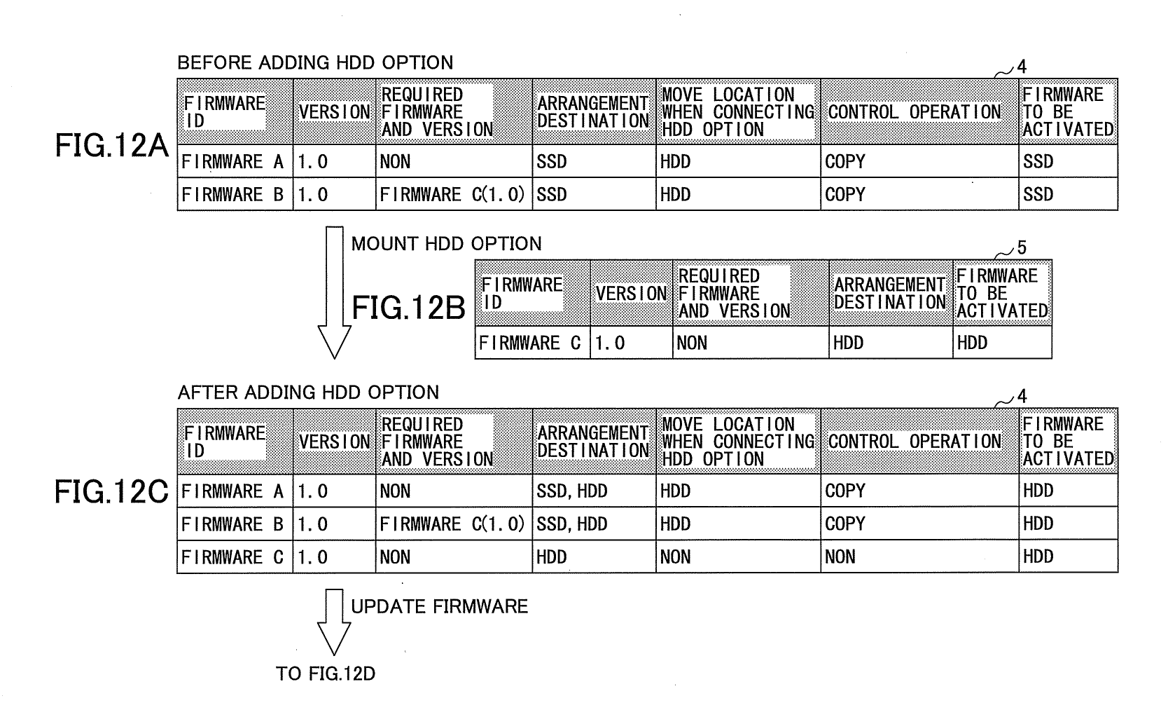

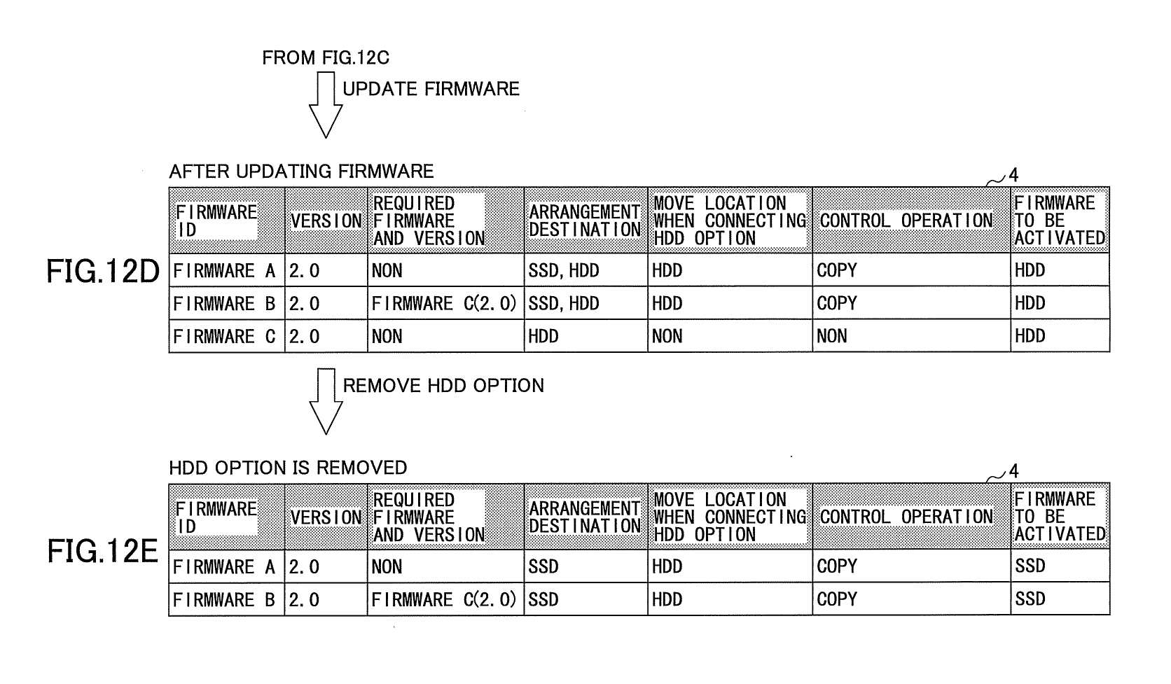

Next, a fourth process operation will be described with reference to FIG. 11A through FIG. 11D and FIG. 12A through FIG. 12E. FIG. 11A through FIG. 11D are diagrams illustrating a state transition of the firmware when the fourth process operation is conducted. FIG. 12A through FIG. 12E are diagrams illustrating the arrangement information 4 in states illustrated in FIG. 11A through FIG. 11D. The fourth process operation will be described in a case in which when the HDD 104 is additionally mounted as the HDD option, the firmware A 201 and the firmware B 202 in the SSD 103 are copied to the HDD 104, and the firmware A 201 and the firmware B 202 in the SSD 103 which are original are retained in the SSD 103. In addition, the firmware A 201 and the firmware B 202 in the SSD 103 are updated as well as those in the HDD 104.

In a case of the controller 100 in the state illustrated in FIG. 11A, the SSD 103 stores the arrangement information 4 illustrated in FIG. 12A beforehand. In the arrangement information 4 illustrated in FIG. 12A, information of the “CONTROL OPERATION” for the “FIRMWARE A” and “FIRMWARE B” indicates to copy (“COPY”). Moreover, the HDD 104, which is added to the controller 100 as the HDD option is mounted, retains the information 5 of the firmware C 203 illustrated in FIG. 12B.

When as illustrated in FIG. 11B, the HDD 104 as the HDD option is additionally mounted in the controller 100 in the state illustrated in FIG. 11A, the SSD 103 controls the firmware A 201 and the firmware B 202 to be the state illustrated in FIG. 11B.

In detail, when the HDD 104 is additionally mounted, the HDD option detecting program 1 copies the firmware A 201 and the firmware B 202 existing in the SSD 103 based on information of the “MOVE LOCATION WHEN CONNECTING HDD OPTION” and the “CONTROL OPERATION” of the arrangement information 4 illustrated in FIG. 12A.

Next, when the HDD 104 as the HDD option is completely mounted to the controller 100, as illustrated in FIG. 12C, the HDD option detecting program 1 updates the arrangement information 4 illustrated in FIG. 12A based on the state illustrated in FIG. 11B.

In detail, since the firmware A 201 is copied to the HDD 104, as illustrated in FIG. 12C, the HDD option detecting program 1 updates information of the “ARRANGEMENT DESTINATION” of the “FIRMWARE A” from “SSD” to “SSD, HDD”, and updates information of the “FIRMWARE TO BE ACTIVATED” from “SSD” to “SSD, HDD”. Also, since the firmware B 202 is copied to the HDD 104, as illustrated in FIG. 12C, the HDD option detecting program 1 updates information of the “ARRANGEMENT DESTINATION” of the “FIRMWARE B” from “SSD” to “SSD, HDD”, and updates information of the “FIRMWARE TO BE ACTIVATED” from “SSD” to “SSD, HDD”. By this control of the HDD option detecting program 1, the firmware A 201 and the firmware B 202, which are copied to the HDD 104, are activated and operate, the firmware A 201 and the firmware B 202 in the SSD 103 are retained as firmware for backup, and the firmware A 201 and the firmware B 202 in the SSD 103 are suppressed not to operate.

Moreover, the HDD 104, which is additionally mounted in the controller 100 as the HDD option, retains the information 5 of the firmware C 203 illustrated in FIG. 12B. Thus, the HDD option detecting program 1 adds the information 5 of the firmware C 203 illustrated in FIG. 12B to the arrangement information 4 illustrated in FIG. 12A based on the information 5 of the firmware C 203 illustrated in FIG. 12B which is retained in the HDD 104, so that the arrangement information 4 is updated as illustrated in FIG. 12C. By using the firmware activating program 3, based on the information of the “FIRMWARE TO BE ACTIVATED” of the arrangement information 4 illustrated in FIG. 12C, the firmware C 203 of the HDD 104 is activated and operates.

Next, in the state illustrated in FIG. 11B, it is assumed that the firmware A 201, the firmware B 202, and the firmware C 203 are updated. In this case, the firmware updating program 2 specifies the arrangement destination of firmware to be updated based on the information of the “ARRANGEMENT DESTINATION” of the arrangement information 4 illustrated in FIG. 12C, and updates the firmware loaded at the specified arrangement destination. In a case of the arrangement information 4 illustrated in FIG. 12C, since the “ARRANGEMENT DESTINATION” of the “FIRMWARE A” indicates “SSD, HDD”, the firmware updating program 2 updates the firmware A 201 existing in the SSD 103 and the firmware A 201 existing in the HDD 104. Since the “ARRANGEMENT DESTINATION” of the “FIRMWARE B” indicates “SSD, HDD”, the firmware updating program 2 updates the firmware B 202 existing in the SSD 103 and the firmware B 202 existing in the HDD 104. Since the “ARRANGEMENT DESTINATION” of the “FIRMWARE C” indicates “HHD”, the firmware updating program 2 updates the firmware C 203 existing in the HDD 104.

Accordingly, the firmware updating program 2 can update the firmware A 201 and the firmware B 202 existing in the SSD 103 other than subjects to be activated, in addition to the firmware A 201 in the HDD 104, the firmware B 202 in the HDD 104, and the firmware C 203 existing in the HDD 104, which are the subjects to be activated. As a result, the firmware updating program 2 updates the arrangement information 4 illustrated in FIG. 12C to be the arrangement information 4 illustrated in FIG. 12D.

Therefore, in the controller 100 according to the embodiment, there is no version difference as illustrated in the state in FIG. 4C between the firmware A′ 201′ and the firmware B 202 in the SSD 103. Thus, as the state in FIG. 11C, the versions of the firmware A′ 201′ and the firmware B′ 202′ are the same.

Accordingly, in a state in which the versions of the firmware A′ 201′ and the firmware B′ 202′ are the same as illustrated in FIG. 11C, it is assumed that an error of the HDD 104 occurs, the HDD 104 as the HDD option is removed, and the state in FIG. 11C is transitioned to the state illustrated in FIG. 11D. Accordingly, in the state illustrated in FIG. 11D, when the firmware A′ 201′ and the firmware B′ 202′ existing in the SSD 103 are activated, operations of the firmware A′ 201′ and the firmware B′ 202′ are normally conducted.

When the HDD 104 as the HDD option is removed, the HDD option detecting program 1 updates information of the “FIRMWARE A”, the “FIRMWARE B”, and the “FIRMWARE C” of the arrangement information 4 illustrated in FIG. 12D, so that the arrangement information 4 is set as illustrated in FIG. 12E. Since the HDD 104 is removed from the controller 100 in FIG. 11D, the information of the “FIRMWARE A” is updated from “SSD, HDD” to “SSD”, and the information of the “FIRMWARE TO BE ACTIVATED” is updated from “HDD” to “SSD”. Also, the information of the “ARRANGEMENT DESTINATION” of the “FIRMWARE B” illustrated in FIG. 12D from “SSD, HDD” to “SSD”, and updates the information of the “FIRMWARE TO BE ACTIVATED” from “HDD” to “SSD”. Furthermore, the HDD option detecting program 1 deletes the information of the “FIRMWARE C” illustrated in FIG. 12D. As a result, the HDD option detecting program 1 updates the arrangement information 4 in FIG. 12D to be the arrangement information 4 in FIG. 12E.

### <Fifth Process Operation>

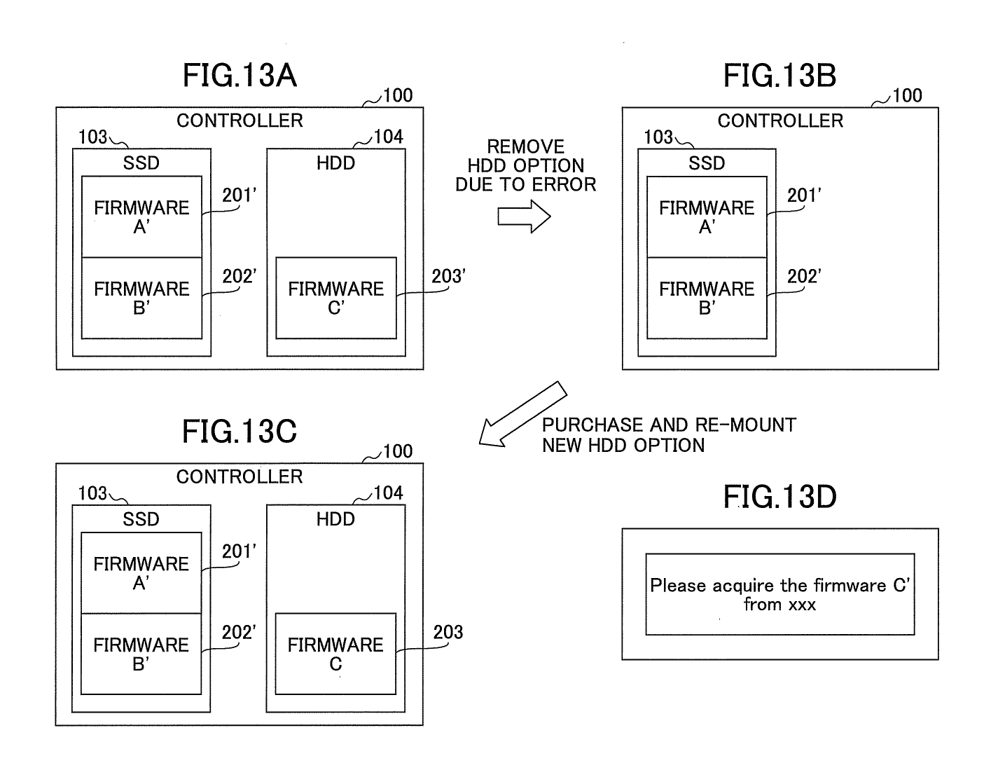

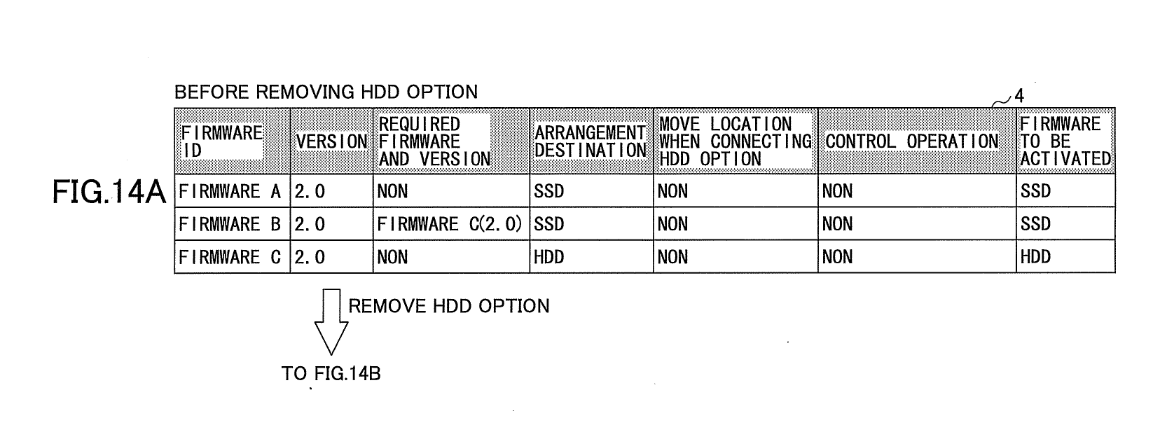

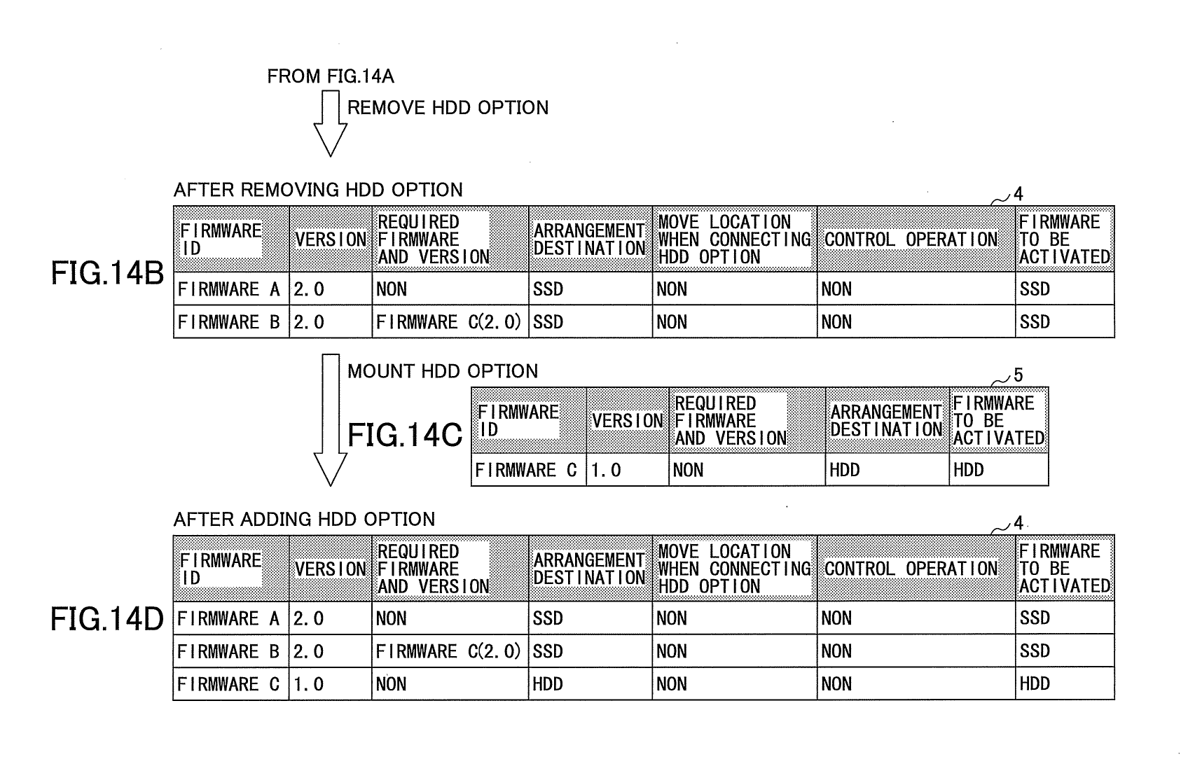

Next, a fifth process operation will be described with reference to FIG. 13A through FIG. 13D and FIG. 14A through FIG. 14D. FIG. 13A through FIG. 13D are diagrams illustrating a state transition of the firmware when the fifth process operation is conducted. FIG. 14A through FIG. 14D are diagrams illustrating the arrangement information 4 in states illustrated in FIG. 13A through FIG. 13D. The fifth process operation will be described in a case in which after the HDD 104 as the HDD option is removed from the controller 100, the HDD 104 is re-mounted in the controller 100.

In a case of the controller 100 in the state illustrated in FIG. 13A, the SSD 103 stores the arrangement information 4 illustrated in FIG. 13A beforehand. Moreover, the HDD 104, which is added to the controller 100 as the HDD option to be mounted, retains the information 5 of the firmware C 203 illustrated in FIG. 14B.

In the state illustrated in FIG. 13A, an error or the like of the HDD 104 occurs, and the HDD 104 as the HDD option is removed. Then, the state illustrated in FIG. 13A is transitioned to the state illustrated in FIG. 13B. When the HDD 104 is removed, the HDD option detecting program 1 updates information of the “FIRMWARE C” of the arrangement information 4 illustrated in FIG. 14A to be the arrangement information 4 illustrated in FIG. 14B. In the state in FIG. 13B, since the HDD 104 is removed from the controller 100, the information of the “FIRMWARE C” is deleted from the arrangement information 4. As a result, the HDD option detecting program 1 updates the arrangement information 4 illustrated in FIG. 14A to be the arrangement information 4 illustrated in FIG. 14B.

When as illustrated in FIG. 13B, the HDD 104 as the HDD option is additionally mounted in the controller 100 in the state illustrated in FIG. 13A, the SSD 103 controls the firmware A′ 201′ and the firmware B′ 202′ to be the state illustrated in FIG. 13C.

In detail, when the HDD 104 is additionally mounted, the HDD option detecting program 1 suppresses copying the firmware A′ 201′, the firmware B′ 202′, and the firmware C 203 based on information of the “MOVE LOCATION WHEN CONNECTING HDD OPTION” and the “CONTROL OPERATION” of the arrangement information 4 illustrated in FIG. 14A.

Next, when the HDD 104 as the HDD option is completely mounted in the controller 100, as illustrated in FIG. 14C, the HDD option detecting program 1 updates the arrangement information 4 illustrated in FIG. 14A based on the state illustrated in FIG. 13B.

In detail, the HDD 104, which is additionally mounted in the controller 100 as the HDD option, retains the information 5 of the firmware C 203 illustrated in FIG. 14B. Thus, the HDD option detecting program 1 adds the information 5 of the firmware C 203 illustrated in FIG. 14B to the arrangement information 4 illustrated in FIG. 14A based on the information 5 of the firmware C 203 illustrated in FIG. 14B which is retained in the HDD 104, so that the arrangement information 4 is updated as illustrated in FIG. 14C. The HDD option detecting program 1 refers to the arrangement information 4 illustrated in FIG. 14D after the update. In this case, the “FIRMWARE B” requires the firmware C 203 of a version 2.0. However, the “VERSION” of the “FIRMWARE C” indicates “1.0”. Thus, it is determined that an inconsistency of the versions occurs. As illustrated in FIG. 13D, the HDD option detecting program 1 displays a screen indicating that the version of the firmware C′ is to be acquired, at a display unit or the like. It is not limited to display the screen indicating that the version of the firmware C′ is acquired as illustrated in FIG. 13D. In order to notify a user of a message, a voice message or the like can be applied. Also, the HDD option detecting program 1 suppresses an operation of the firmware C 203 having a different version from that of the firmware B 202.

As illustrated in FIG. 13C, when the HDD 104 is additionally mounted as the HDD option, the firmware A′ 201′, the firmware B′ 202′, and the firmware C 203 are combined, and this firmware combination fails to operate due to inconsistency of the versions. When the HDD 104 as the HDD option is additionally mounted, the HDD option detecting program 1 conducts a version check between the firmware A′ 201′ and B′ 202′in the SSD 103 and the firmware C 203 in the HDD 104. Then, when detecting the inconsistency of the versions, the HDD option detecting program 1 warns the user to acquire the firmware C′ 203′, so as to urge the user to acquire and cause combined firmware having the consistency of the versions to normally operate. Moreover, since the HDD option detecting program 1 conducts the version check, it is possible to suppress an operation of the firmware C 203, and to prevent the error in which the combined firmware fails to normally operate.

### <Sixth Process Operation>

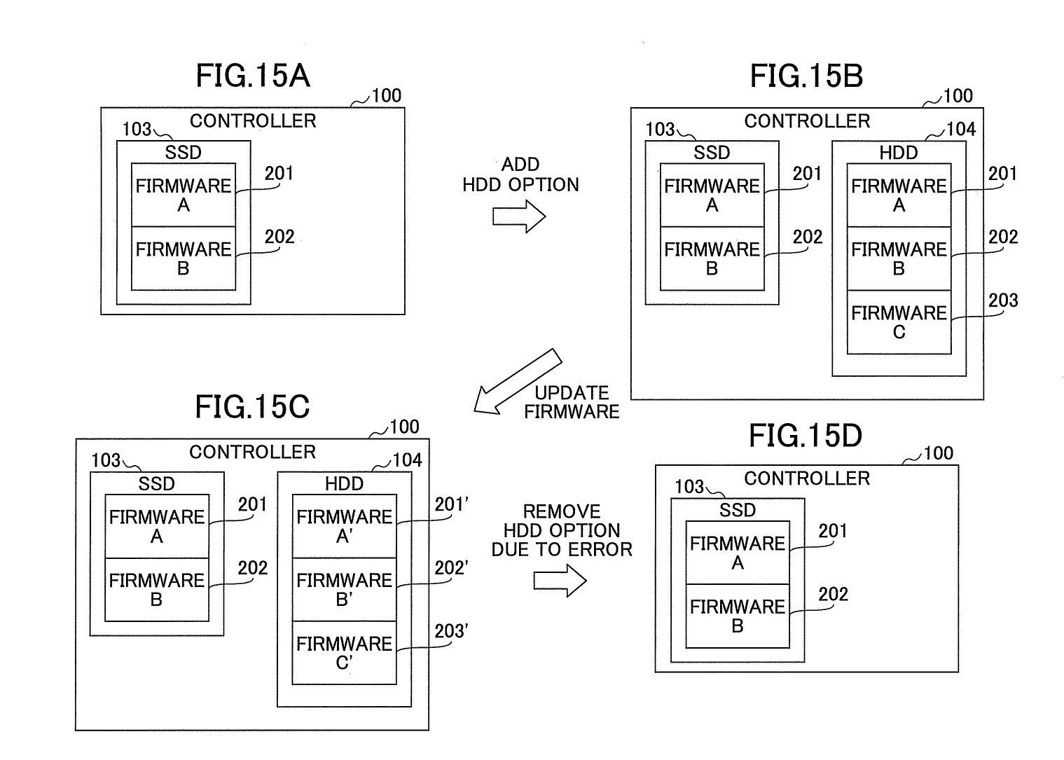

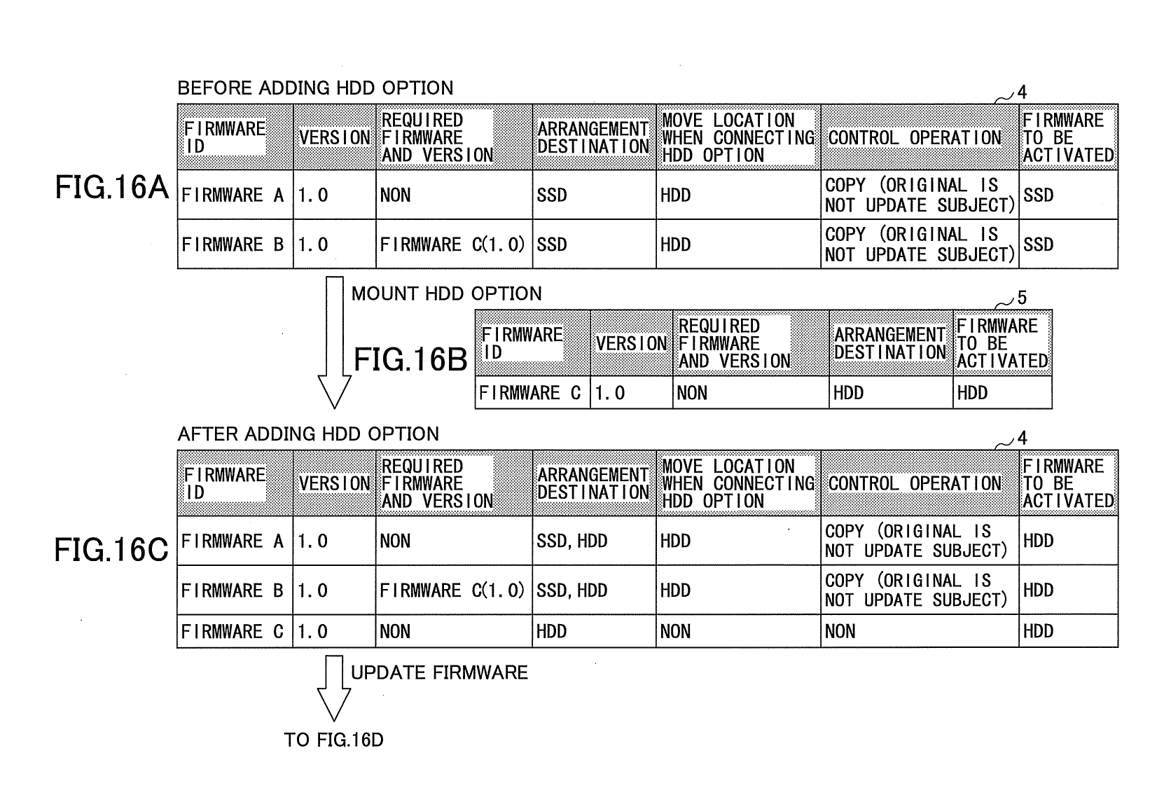

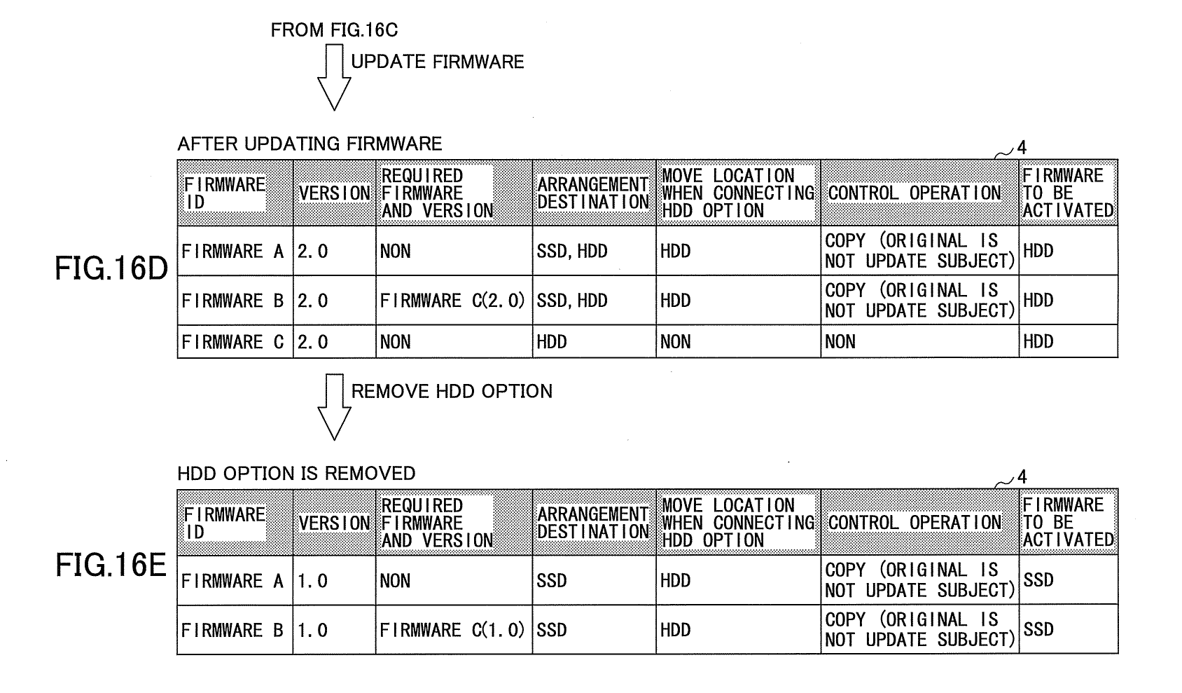

Next, a sixth process operation will be described with reference to FIG. 15A through FIG. 15D and FIG. 16A through FIG. 16E. FIG. 15A through FIG. 15D are diagrams illustrating a state transition of the firmware when the sixth process operation is conducted. FIG. 16A through FIG. 16E are diagrams illustrating the arrangement information 4 in states illustrated in FIG. 15A through FIG. 15D. The sixth process operation will be described in a case in which when the HDD 104 is additionally mounted as the HDD option, the firmware A 201 and the firmware B 202 in the SSD 103 are copied to the HDD 104, and the firmware A 201 and the firmware B 202 in the SSD 103 which are original are retained in the SSD 103. However, the firmware A 201 and the firmware B 202 in the SSD 103 are not updated.

In a case of the controller 100 in the state illustrated in FIG. 15A, the SSD 103 stores the arrangement information 4 illustrated in FIG. 16A beforehand. In the arrangement information 4 illustrated in FIG. 16A, information of the “CONTROL OPERATION” for the “FIRMWARE A” and “FIRMWARE B” indicates to copy (“COPY”). It should be noted that original firmware is not a copy subject. That is, the firmware A 201 and the firmware B 202 in the SSD 103 are set not to be updated. Also, the HDD 104 as the HDD option is additionally mounted in the controller 100, and retains information 5 of the firmware C 203 illustrated in FIG. 16B.

When as illustrated in FIG. 15B, the HDD 104 is added to the controller 100 in a state illustrated in FIG. 15A as the HDD option, the SSD 103 controls the firmware A 201 and the firmware B 202 to be a state illustrated in FIG. 15B.

In detail, when the HDD 104 is additionally mounted, the HDD option detecting program 1 copies the firmware A 201 and the firmware B 202 existing in the SSD 103 based on information of the “MOVE LOCATION WHEN CONNECTING HDD OPTION” and the “CONTROL OPERATION” of the arrangement information 4 illustrated in FIG. 16A.

Next, when the HDD 104 as the HDD option is completely mounted, as illustrated in FIG. 16C, the HDD option detecting program 1 updates the arrangement information 4 illustrated in FIG. 16A based on the state illustrated in FIG. 15B.

In detail, since the HDD option detecting program 1 copies the firmware A 201 to the HDD 104, as illustrated in FIG. 16C, the HDD option detecting program 1 updates information of the “ARRANGEMENT DESTINATION” of the “FIRMWARE A” from “SSD” to “SSD, HDD”, and updates information of the “FIRMWARE TO BE ACTIVATED” from “SSD” to “SSD, HDD”. However, the “FIRMWARE A” of the “SSD” at the “ARRANGEMENT DESTINATION” is set not to be an update subject. Moreover, since the firmware B 202 is copied to the HDD 104, as illustrated in FIG. 16C, the HDD option detecting program 1 updates information of the “ARRANGEMENT DESTINATION” of the “FIRMWARE B” from “SSD” to “SSD, HDD”, and updates information of the “FIRMWARE TO BE ACTIVATED” “SSD” to “HDD”. However, the “FIRMWARE B” of the “SSD” of the “ARRANGEMENT DESTINATION” is set not to be the update subject. Thus, the firmware A 201 and the firmware B 202 copied to the HDD 104 can be caused to operate, the firmware A 201 and the firmware B 202 which are original in the SSD 103 can be set to be firmware for backup, and operations of the firmware A 201 and the firmware B 202 in the SSD 103 can be suppressed. Also, it is possible to set the firmware A 201 and the firmware B 202 which are original in the SSD 103 to be out of the update subject.

Also, since the HDD 104, which is added to the controller 100 as the HDD option to be mounted, retains information of the firmware C 203 illustrated in FIG. 16B, the HDD option detecting program 1 adds the information of the firmware C 203 illustrated in FIG. 16B to the arrangement information 4 illustrated in FIG. 16A based on the information of the firmware C 203 illustrated in FIG. 16B which the HDD 104 retains, so as to update as illustrated in FIG. 16C. Thus, the firmware activating program 3 causes the firmware C 203 to activate and operate based on the information of the “FIRMWARE TO BE ACTIVATED” of the arrangement information 4 illustrated in FIG. 16C.

Next, in the state illustrated in FIG. 15B, it is assumed that the firmware is updated. In this case, the firmware update program 2 specifies the arrangement destination of the firmware which is the update subject based on the information of the “ARRANGEMENT DESTINATION” of the arrangement information 4 illustrated in FIG. 16C, so as to update the firmware at the arrangement destination. In a case of the arrangement information 4 illustrated in FIG. 16C, since the “ARRANGEMENT DESTINATION” of the “FIRMWARE A” indicates “SSD, HDD”, and “SSD” is set not to be an update subject, the firmware update program 2 does not update the firmware A 201 existing in the SSD 103 and updates only the firmware A 201 existing in the HDD 104. Also, since the “ARRANGEMENT DESTINATION” of the “FIRMWARE B” indicates “SSD, HDD”, and “SSD” is set not to be an update subject, the firmware update program 2 does not update the firmware existing in SSD 103 and updates only the firmware B 202 existing in the HDD 104. The “ARRANGEMENT DESTINATION” of the “FIRMWARE C” indicates “HDD”, the firmware update program 2 updates the firmware C 203 existing in the HDD 104.

As described above, by using the firmware update program 2, only the firmware A 201, the firmware B 202, and the firmware C 203, which exist in the HDD 104 and are subjects to be activated, can be updated. In addition, it is possible to suppress updating the firmware A 201 and the firmware B 202, which exist in the SSD 103 and are not the subject to be activated. As a result, by using the firmware updating program 2, it is possible to update the arrangement information 4 illustrated in FIG. 16C to be the arrangement information 4 illustrated in FIG. 16D.

Accordingly, in the controller 100 according to the embodiment, there is no version difference between the firmware A′ 201′ and the firmware B 202 which exist in the SSD 103 as illustrated in FIG. 4C. As illustrated in FIG. 15C, both versions of the firmware A 201 and the firmware B 202 which exist in the SSD 103 can be the same version.

Accordingly, in the state in which the version of the firmware A 201 is the same as that of the firmware

B 202 in the SSD 103 as illustrated in FIG. 15C, it is assumed that an error of the HDD 104 occurs, the HDD 104 as the HDD option is removed, and the state illustrated in FIG. 15C is transitioned to the state illustrated in FIG. 15D. In the state illustrated in FIG. 15D, when both the firmware A 201 and the firmware B 202 existing in the SSD 103 are activated, both the firmware A 201 and the firmware B 202 can normally operate.

When the HDD 104 as the HDD option is removed, the HDD option detecting program 1 updates information of the “FIRMWARE A”, the “FIRMWARE B”, and the “FIRMWARE C” of the arrangement information 4 illustrated in FIG. 16D to be the arrangement information 4 illustrated in FIG. 16E. In FIG. 16D, since the HDD 104 is removed from the controller 100, information of the “ARRANGEMENT DESTINATION” of the “FIRMWARE A” is updated from “SSD, HDD” to “SSD”, and information of the “FIRMWARE TO BE ACTIVATED” is updated from “SSD, HDD” to “SSD”. It should be noted that since “SSD” is set to be a non-update subject, the HDD option detecting program 1 updates information of the “VERSION” from “2.0” to “1.0” to be back to a previous version “1.0”. Moreover, the HDD option detecting program 1 updates information of the “ARRANGEMENT DESTINATION” of the “FIRMWARE B” illustrated in FIG. 16D from “SSD, HDD” to “SSD”, and updates information of the “FIRMWARE TO BE ACTIVATED” from “HDD” to “SSD”. It should be noted that since “SSD” is set to be the non-update subject, the HDD option detecting program 1 updates information of the “VERSION” from “2.0” to “1.0” to be back to a previous version “1.0”. Moreover, the HDD option detecting program 1 deletes the information of the “FIRMWARE C” illustrated in FIG. 16D. As a result, the HDD option detecting program 1 updates the arrangement information 4 illustrated in FIG. 16D to be the arrangement information 4 illustrated in FIG. 16E.

### Operation and Advantage of the Information Processing Apparatus According to Embodiment

As described above, the information processing apparatus according to the embodiment manages the arrangement information 4 of firmware existing in devices such as the SSD 103, the HDD (Hard Disk Drive) 104, and the like, and controls versions of one firmware and another firmware existing in the SSD 103 to be the same based on the arrangement information 4 when the versions of one firmware and another firmware are updated. Even in a case in which a device such as the HDD 104 or the like is additionally mounted, information of one firmware and another firmware existing in the device can be managed in the arrangement information 4, and the versions of one firmware and another firmware existing in another device such as the SSD 103 can be the same.

According to the embodiment, even in a case in which a device such as the HDD 104 or the like is additionally mounted, it is possible to maintain a version consistency among versions of more than one firmware existing in the SSD 103.

The present invention is not limited to the specifically disclosed embodiments, and variations and modifications may be made without departing from the scope of the invention.

For example, control operations, conducted by devices included in the controller 100 of the information processing apparatus according to the embodiment described above, can be performed by hardware or software, or a combined configuration thereof.

In a case of conducting a process by using software, it is possible to install a program recording a process sequence into a memory mounted in special hardware in a computer and execute the program. Alternatively, each of various processes installs the program into a general-purpose computer so that the program is executed by the general-purpose computer.

For example, the program can be recorded in a hard disk or a ROM (Read Only Memory) such as a recording medium beforehand. Alternatively, the program can be temporarily or permanently stored (recorded) in a removable recording medium. This removable recording medium can be provided as so-called package software. The removable recording medium can be a floppy disk, a CD-ROM (Compact Disc Read Only Memory), a MO (Magneto optical) disk, a DVD (Digital Versatile Disc), a Blu-ray Disc, a magnetic disk, a semiconductor memory, and the like.

The program is installed into the computer from the above-described removable recording medium. Also, the program can be transferred to the computer by radio transmission from a download site. Moreover, the program can be transferred to the computer by a fixed line through a network.

Accordingly, the information processing apparatus according to the embodiment can be performed in time series in accordance with the above-described process operation. Moreover, in the information processing apparatus, the above-described process operation is performed in parallel or separately if necessary.

The present application is based on the Japanese Priority Patent Application No.2010-036447 filed on Feb. 22, 2010 the entire contents of which are hereby incorporated by reference.

What is claimed is:

1. An information processing apparatus, comprising:
a management part configured to manage arrangement information of multiple firmware programs existing in a solid state drive and a device other than the solid state drive;
a control part configured to control versions of the multiple firmware programs existing in the solid state drive based on the arrangement information managed by the management part to be a same version, when the versions of the multiple firmware programs are updated.

2. The information processing apparatus as claimed in claim 1, wherein in a case in which the device other than the solid state drive is additionally mounted, at least one firmware program existing in the solid state drive is copied to the device, and the versions of the multiple firmware programs are updated, if an original firmware program of the at least one firmware program copied to the device exists in the solid state drive, the control part updates the at least one firmware program copied to the device and the original firmware program existing in the solid state drive.

3. The information processing apparatus as claimed in claim 1, wherein in a case in which the device other than the solid state drive is additionally mounted, a reference function to refer to at least one firmware program existing in the solid state drive is copied to the device, and the versions of the multiple firmware programs are updated, if the reference function exists in the device, the control part updates the at least one firmware program existing in the solid state drive referred to by the reference function.

4. The information processing apparatus as claimed in claim 1, wherein in a case in which the device other than the solid state drive is additionally mounted, the multiple firmware programs existing in the solid state drive are copied, and the versions of the multiple firmware programs are updated, if there is a firmware program which is not copied to the device in the solid state drive, the control part updates the firmware program which is not copied in the solid state drive.

5. The information processing apparatus as claimed in claim 1, wherein in a case in which the device other than the solid state drive is additionally mounted, all of the multiple firmware programs existing in the solid state drive are copied, and the versions of the multiple firmware programs are updated, if all of the multiple firmware programs copied to the device exist in the solid state drive, the control part updates all of the multiple firmware programs copied to the device and all original firmware programs existing in the solid state drive of the multiple firmware programs.

6. The information processing apparatus as claimed in claim 1, wherein in a case in which the device other than the solid state drive is additionally mounted, all of the multiple firmware programs existing in the solid state drive are copied, and the versions of the multiple firmware programs are updated, if multiple original firmware programs of all of the multiple firmware programs copied to the device exist in the solid state drive, the control part updates all of the multiple firmware programs copied to the device, and suppresses updating all of the multiple original firmware programs existing in the solid state drive.

7. The information processing apparatus as claimed in claim 1, wherein in a case in which the device other than the solid state drive is additionally mounted, the control part checks the versions of more than one firmware program existing in the device and the versions of the multiple firmware programs existing in the solid state drive, and reports a version inconsistency if the versions of more than one firmware program existing in the device are different from the versions of the multiple firmware programs existing in the solid state drive.

8. The information processing apparatus as claimed in claim 1, wherein in a case in which the device other than the solid state drive is additionally mounted, the control part checks the versions of more than one firmware program existing in the device and the versions of the multiple firmware programs existing in the solid state drive, and controls a firmware program having a version inconsistency between the solid state drive and the device not to operate if the versions of more than one firmware program existing in the device are different from the versions of the multiple firmware programs existing in the solid state drive.
